(19) United States
(12) Patent Application Publication
(10) Pub. No.: US 2025/0023128 A1
(43) Pub. Date: Jan. 16, 2025

(54) WAVELENGTH DEPENDENCE IN ELECTRODE PHOTO-ACCELERATED FAST CHARGING AND DISCHARGING

(71) Applicants: UChicago Argonne, LLC, Chicago, IL (US); New York University, New York, NY (US); Northern Illinois University, DeKalb, IL (US)

(72) Inventors: Christopher S. Johnson, Willow Springs, IL (US); Yingwen Cheng, Chicago, IL (US); Bowen AN, Chicago, IL (US); Yaxin Shen, Chicago, IL (US); Andre Taylor, Chicago, IL (US); Jason Lipton, Chicago, IL (US); Yuanyuan MA, Chicago, IL (US)

(73) Assignees: UChicago Argonne, LLC, Chicago, IL (US); New York University, New York, NY (US); Northern Illinois University, DeKalb, IL (US)

(21) Appl. No.: 18/765,169

(22) Filed: Jul. 5, 2024

Related U.S. Application Data
(60) Provisional application No. 63/525,229, filed on Jul. 6, 2023.

(51) Int. Cl. H01M 10/44; H01M 4/485; H01M 4/505; H01M 10/0525

(52) U.S. Cl. CPC H01M 10/44; H01M 4/485; H01M 4/505; H01M 10/0525

(57) ABSTRACT

A process for charging a discharged electrochemical cell includes applying a voltage bias to the discharged electrochemical cell; and illuminating the cathode, the anode, or both the cathode and the anode with light having a narrow band of wavelengths corresponding to the respective band gaps of the electrode active materials.

### CROSS-REFERENCE TO RELATED APPLICATIONS

This application claims priority to and the benefit of U.S. Provisional Patent App. No. 63/525,229, filed Jul. 6, 2024, the content of which is incorporated by reference in its entirety.

### STATEMENT OF GOVERNMENT INTEREST

This invention was made with government support under CHE0840277,DMR0820341, and DMR1420073 awarded by the National Science Foundation and DE-AC02-06CH11357 awarded by the United States Department of Energy. The government has certain rights in the invention.

### TECHNICAL FIELD

The present technology is generally related to rechargeable electrochemical cells, and more specifically is related to radiating an electrode with light shone during the recharge cycle.

### BACKGROUND

Lithium-ion batteries are typically slow-charged in order to promote longer battery cycle life, obtain higher charge capacity of the battery, and avoid certain deleterious phenomena that typically occur when charging the battery quickly. Conventionally, fast charging leads to unavoidable temperature increases inside of the battery due to resistive heating (e.g. i²R heating). Inductive (wireless) charging also intrinsically heats the battery. High temperatures inside the battery may cause degradation of the battery materials, decreasing battery cycle life and can even lead to thermal runaway.

However, fast charging of lithium-ion batteries is a factor in efforts to increase electric vehicle adoption. Slow vehicle charging is a large contributor to “range anxiety” amongst consumers, where a driver fears that their electric vehicle has insufficient energy storage to cover the road distance needed to reach its intended destination and thus the driver will be stranded mid-way. Reducing the time it takes to charge the battery would help with electric vehicle adoption and reduce range anxiety.

### SUMMARY

An electrochemical cell employing photo-accelerated charging and discharging processes has fast charge and discharge rates substantially without the deleterious effects associated with fast charging and discharging. The photo-accelerated charging and discharging processes use light with a narrow wavelength band matching or overlapping with the band gap of the electrode active material. Because the light has a narrow wavelength band, illuminating the electrode active material does not substantially increase the temperature in the electrochemical cell during charging.

In one aspect, a method of charging a discharged electrochemical cell from a first discharged state to a first charged state is provided. The discharged electrochemical cell includes a cathode active material having a cathode band gap, an anode active material having an anode band gap, and an electrolyte. The method includes determining a band gap of the cathode active material, a band gap of the anode active material, or a band gap of each of the cathode active material and the anode active material. The method also includes illuminating the cathode active material with light having a first range of wavelengths that overlaps with the band gap of the cathode active material, illuminating the anode active material with light having a second range of wavelengths that overlaps with the band gap of the anode active material; or illuminating both the cathode active material with light having a first range of wavelengths that overlaps with the band gap of the cathode active material and the anode active material with light having a second range of wavelengths that overlaps with the band gap of the anode active material. The method also includes applying a voltage bias to charge the discharged electrochemical cell from the first discharged state to the first charged state. The electrochemical cell is a lithium ion battery, a sodium ion battery, a potassium ion battery, a magnesium ion battery, a lithium-air or lithium oxygen battery, or a lithium-sulfur battery. A time period required to charge the discharged electrochemical cell from the first discharged state to the first charged state while illuminated is less than a time period required for charging the discharged electrochemical cell while not illuminated or illuminated with light that does not have a wavelength that overlaps with the band gap of the cathode active material, the anode active material, or both the cathode active material and the anode active material.

In another aspect, a method of discharging a charged electrochemical cell from a first charged state to a first discharged state is provided. The charged electrochemical cell includes a cathode active material having a cathode band gap, an anode active material having an anode band gap, and an electrolyte. The method includes determining a band gap of the anode active material. The method also includes illuminating the anode active material with light having a first range of wavelengths that overlaps with the band gap of the anode active material. The method also includes applying a constant current to discharge the charged electrochemical cell from the first charged state to the first discharged state. A time period required to discharge the charged electrochemical cell from the first charged state to the first discharged state while illuminated is less than a time period required for discharging the charged electrochemical cell while not illuminated or illuminated with light that does not have a wavelength that overlaps with the band gap of the anode active material.

In some embodiments, the range of the first wavelength of light substantially matches the band gap of the cathode active material, and the range of the second wavelength of light substantially matches the band gap of the anode active material. In some embodiments, the range of first wavelengths of light is within the band gap of the cathode active material, and the range of second wavelengths of light is within the band gap of the anode active material. The light may be red light and/or ultraviolet light. A source of the red light or ultraviolet light may be a light emitting diode, a xenon lamp, or a laser. The electrochemical cell may be a lithium ion battery. The electrochemical cell may be a sodium ion battery. The electrochemical cell may be a potassium ion battery. The electrochemical cell may be a magnesium ion battery. The electrochemical cell may be a lithium-air battery or lithium-oxygen battery. The electrochemical cell may be a lithium-sulfur battery.

In some embodiments, the cathode active material includes a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ}′O_{2-z″}F_{z″}, A_{n′}B¹₂(M²O₄)₃, or VO₂. M⁴ may be Al, Mg, Ti, B, Ga, Si, Mn, or Co. M⁵ may be Mg, Zn, Al, Ga, B, Zr, or Ti. A may be Li, Ag, Cu, Na, Mn, Fe, Co, Ni, Cu, or Zn. B¹ may be Ti, V, Cr, Fe, or Zr. The variables in the chemical formulae may be 0≤x≤0.3, 0≤y≤0.5, 0≤z≤0.5, 0≤x″≤0.4, 0≤α≤1, 0≤β≤1, 0≤γ≤1, 0≤δ′≤0.4, 0≤z″≤0.4, 0≤n′≤3, and at least one of α, β and γ may be greater than 0.

In some embodiments, the cathode active material includes LiFePO₄, LiCoO₂, LiNiO₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCoMnO₄, LiNi_{0.5}Mn_{1.5}O₄, LiNiPO₄, LiCoPO₄, LiMnPO₄, LiCOPO₄F, LizMnO₃, Li₅FeO₄, or Li_{x′}(Met)O₂, where Met is a transition metal and 1<x′≤2.

In some embodiments, the anode active material includes lithium, sodium, magnesium, sulfur, a conductive carbon material, silicon, silicon oxide, TiO₂, Li₄Ti₅O₁₂, or a mixture of any two or more thereof. The discharged electrochemical cell may further include a separator between the cathode and the anode.

### BRIEF DESCRIPTION OF DRAWINGS

FIG. 1 is an illustration of a modified coin cell amenable to light impingement through a sealed quartz window and a transparent current collector, according to an embodiment.

FIG. 2 is an illustration of another modified coin cell amendable to light impingement through a sealed quartz window and a grid current collector, according to an embodiment.

FIG. 3 is a flow chart of a process for fast charging using light irradiation of an electrode.

FIG. 4 is a UV/Vis (ultraviolet/visible) absorption spectra of a thin film LMO (spinel LiMn₂O₄), and a chemically delithiated LMO.

FIG. 5 is a graph of the density of states of LMO and λ-MnO₂.

FIG. 6A is a chronoamperometry graph at 4.07 V (left-y) and a chronocoulometry (right-y) graph during illumination of a windowed coin cell, according to the examples.

FIG. 6B is a constant current discharge plot following photo-accelerated charging, according to the examples. Note that discharge in FIG. 6B was done in the dark, and the light sources in the legend correspond to the illumination shown in FIG. 6A.

FIG. 7 is a schematic representation of the difference between absorption mechanisms under UV and red light illumination, according to the Examples. As shown, UV light does not promote an electron to the Mn-e_{g} band from the t_{2g} band whereas red light does promote the electron. The curved arrows represent increased current in an external circuit and ejection of Li⁺ under illumination.

FIGS. 8A, 8B, 8C, and 8D show X-ray absorption near edge structure (XANES) spectra for LMO electrodes under dark conditions and red light at 0% state of charge (“SOC”) (FIG. 8A) and 100% SOC (FIG. 8B), and under UV light illumination at 0% SOC (FIG. 8C) and 100% SOC (FIG. 8D), according to the examples.

FIGS. 9A, 9B, 9C, 9D, 9E, and 9F show X-ray absorption fine structure (XFAS) spectra for LMO electrodes under dark conditions and red light at 0% SOC (FIG. 9A) and 100% SOC (FIG. 9B), under UV light at 0% SOC (FIG. 9C) and 100% SOC (FIG. 9D), and XAFS fitting curves for the 2^{nd} shell of LMO, comparing spinel Mn-Mn distance in the dark to red (FIG. 9E) and UV (FIG. 9F) illumination, according to the examples. The error bars in FIGS. 9E and 9F are related to the fitting parameters.

FIG. 10A is a chronoamperometry graph of an LTO half-cell at 1.2 V comparing UV light illumination and dark conditions.

FIG. 10B is a chronoamperometry graph of an LTO half-cell at 1.2 V comparing red light illumination and dark conditions.

FIG. 10C is a chronocoulometry graph of an LTO half-cell comparing illuminated conditions.

FIG. 10D shows electrochemical impedance spectroscopy (EIS) curves of an LTO half-cell obtained under illumination and dark conditions measured at open circuit voltage.

FIGS. 11A to 11C show chronoamperometry graphs of closed coin cells with different current collectors. FIG. 11A shows data from coin cell 1 with a LTO on Cu foil anode electrode and a LMO on Al foil cathode electrode. FIG. 11B shows data from coin cell 2 with a LTO on Ni foam anode electrode and a LMO on ITO/PET cathode electrode. FIG. 11C shows data from coin cell 3 with a LTO on Cu mesh anode electrode and a LMO on Al mesh cathode electrode.

FIG. 12A is a graph showing the charging of coin cell 3 at different constant voltages. FIG. 12B is a graph showing 20 charge/discharge cycles of coin cell 3.

FIG. 12C is a graph showing the slope of E capacity curve of the third galvanostatic cycle in coin cell 3.

FIG. 12D is a graph showing the voltage change during the third galvanostatic cycle in coin cell 3.

FIGS. 13A to 13D show electrochemical measurements of coin cell 4 with an LTO electrode facing the coin cell window. FIG. 13A shows galvanostatic cycles. FIG. 13B shows EIS. FIG. 13C shows cell charging at a constant voltage of 2.75 V. FIG. 13D shows cell discharge at 0.1 C after constant voltage charging.

FIGS. 14A to 14D show electrochemical measurements of coin cell 5 with LMO facing the coin cell window. FIG. 14A shows galvanostatic cycles. FIG. 14B shows EIS. FIG. 14C shows cell charging at a constant voltage of 2.75 V. FIG. 14D shows cell discharge at 0.1 C after constant voltage charging.

FIGS. 15A to 15D show electrochemical measurements of coin cell 6 with LTO facing the coin cell window. FIG. 15A shows galvanostatic cycles. FIG. 15B shows EIS. FIG. 15C shows cell charging at a constant voltage of 2.75 V constant voltage. FIG. 15D shows cell discharge at 0.1 C after constant voltage charging.

FIGS. 16A to 16D show electrochemical measurements of coin cell 7 with LTO facing the coin cell window. FIG. 16A shows galvanostatic cycles. FIG. 16B shows EIS. FIG. 16C shows cell charging at a constant voltage of 2.75 V. FIG. 16D shows cell discharge at 0.1 C after constant voltage charging.

FIG. 17A shows galvanostatic cycling of coin cell 8, an LTO half-cell without illumination.

FIG. 17B is a cyclic voltammetry (CV) graph of coin cell 8.

FIG. 17C is a linear fitting graph of the CV data in FIG. 17B.

FIG. 18A shows galvanostatic cycling of coin cell 9, an LMO half-cell.

FIG. 18B is a CV graph of coin cell 9 under dark conditions.

FIG. 18C is a CV graph of coin cell 9 under illumination with red light having a wavelength of 623 nm.

FIG. 18D is a linear fitting graph of peak 1 in the CV data in FIGS. 18B and 18C.

FIG. 18E is a linear fitting graph of peak 2 in the CV data in FIGS. 18B and 18C.

FIG. 19A shows charging and discharging of a Li-rich cathode under different illumination conditions.

FIG. 19B shows voltage profiles of charging a Li-rich cathode under different illumination conditions.

FIG. 20A shows charging and discharging of a LNMO (LiNi_{0.5}Mn_{1.5}O₄ spinel) cathode under different illumination conditions.

FIG. 20B shows voltage profiles of charging a LNMO (LiNi_{0.5}Mn_{1.5}O₄ spinel) cathode under different illumination conditions.

FIG. 21A shows constant voltage discharging of a graphite anode illuminated with red light having a wavelength of 623 nm.

FIG. 21B shows voltage profiles of a graphite anode illuminated with red light having a wavelength of 623 nm.

FIG. 21C shows charging and discharging of a graphite anode illuminated with red light having a wavelength of 623 nm.

FIGS. 22A to 22D are Nyquist plots of a graphite anode under different illumination conditions and different states of charge.

FIG. 23 is a graph of the voltage profile of a graphite anode.

FIG. 24 is a graph of light intensity versus driving current for graphite anodes illuminated with UV light or red light.

FIGS. 25A-25E show Nyquist plots of a graphite anode at different lithiation states and under different illumination conditions.

FIGS. 26A and 26B provide a schematic of a lithium-ion cell with a graphite anode with a solid-electrolyte interphase and the corresponding equivalent circuit model, respectively.

FIGS. 27A-27C show graphs of EIS equivalent circuit fitting result of Ohmic resistance (FIG. 27A); charge resistance at the electrolyte-SEI interface (FIG. 27B); and charge transfer resistance at the graphite-electrolyte interface (FIG. 27C).

FIGS. 28A-28C show graphs of resistance decrease ratios comparing illumination with red light or UV light as compared to dark conditions using the values in FIGS. 27A-27C.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Disclosed herein are electrochemical cells (e.g., rechargeable batteries) and processes that allow for fast direct current charging and recharging without the severe effects produced through resistive heating. Charging is accomplished by irradiating the cathode electrode, the anode electrode, or both the cathode electrode and the anode electrode with light (also called electromagnetic radiation) while the battery is being charged or recharged. This process is sometimes called photo-accelerated fast charging. During photo-accelerated fast charging, the electrode(s) are irradiated with discrete optical wavelengths or narrow optical wavelength bands overlapping with the band gap(s) of the electrode(s) active material. When irradiated with narrowband wavelengths overlapping with its band gap, the electrode charged faster without detectable deleterious side effects in the battery, or destruction of the ability of the electrode to operate normally.

Also disclosed are electrochemical cells (e.g., rechargeable batteries) and processes that allow for fast direct current discharging without the severe effects produced through resistive heating. Discharging is accomplished by irradiating the anode electrode, with light (also called electromagnetic radiation) while the battery is being discharged. This process is sometimes called photo-accelerated fast discharging. During photo-accelerated fast discharging, the anode is irradiated with discrete optical wavelengths or narrow optical wavelength bands overlapping with the band gap of the anode active material. When irradiated with narrowband wavelengths, the anode discharged faster without, or with only substantially little, deleterious side effects in the battery, or destruction of the ability of the anode to normally operate. In some embodiments, photo-accelerated fast discharging is paired with photo-accelerated fast charging. In other embodiments, only one of photo-accelerated fast charging or photo-accelerated fast discharging are employed.

Besides fast charging and discharging, using discrete optical wavelengths or narrow optical wavelength bands for photo-accelerated fast charging and discharging has several benefits. Light having wavelengths that do not overlap with the bandgap(s) of the electrode active materials may not support photo-accelerated processes. Therefore, total light efficiency is increased by narrowly tailoring the irradiation light to overlap with the band gap(s) of the electrode active materials. Furthermore, since the total amount of light used for photo-accelerated charging and discharging is limited to narrowband wavelengths, the temperature of the battery during irradiation shows no, or substantially little, heating during charging.

Without being bound by any theory, irradiation of the electrode(s) with discrete optical wavelengths or narrow optical wavelength bands induces light-matter interactions with the electrode active material in the electrode. These light-matter interactions may locally alter the electronic nature of the electrode active material. Specifically, the electrode active material may absorb photons of light at the discrete wavelengths, causing electron excitation from the valence band to the conduction band. Electron excitation may facilitate electron movement and reduce the resistance to the flow of charge in the electrochemical cell. The wavelength range of the incident light is selected to have enough energy to induce relevant electronic excitations in the electrode active material while still being narrow enough to limit the total amount of light irradiation. Limiting the total amount of light illumination prevents or substantially reduces local heating of the electrochemical cell and increases photo-accelerated fast charging efficiency.

The discrete optical wavelengths or narrow optical wavelength bands have an energy matching, overlapping, or slightly higher than the energy of the band gap of the electrode material. If the photon energy is less than the energy of the band gap, then there is not sufficient energy to promote an electron from the valence band into the conduction band. If the photon energy is substantially higher than the energy of the band gap, then the photon energy may not match an energy level in the density of states of the electrode active material, and the photon energy may not promote the electron from the valence band into the conduction band. When the photon energy matches the energy of the band gap or otherwise has an energy that matches an energy level in the conduction band of the electrode active material, then the electrode active material may absorb the photon and excite an electron into the conduction band. Thus, the discrete optical wavelengths or short optical wavelength bands used to facilitate fast charging match the energy of the band gap of the electrode active material or otherwise have energies that match energy levels in the conduction band of the electrode active material.

The discrete optical wavelengths or narrow optical wavelength bands used for fast charging may be determined by determining the energy of the band gap of the electrode active material(s) of the electrode(s) and/or determining the density of states of the electrode active material(s). For reference, the band gap of the electrode active material may be the difference in energy between the Fermi level and an excited electronic state above the Fermi level in the electrode active material. For example, the excited electronic states above the Fermi level in the electrode active material may be t_{2g} and e_{g} electronic states. Photo-assisted electron excitation into these excited electronic states may facilitate fast charging. Thus, in some embodiments, the electrode active material may have t_{2g} and/or e_{g} electronic states above the Fermi level that facilitate photo-accelerated charging.

The band gap of the electrode active material may be calculated physically or theoretically using any reasonable methods. For example, the band gap of the electrode active material may be calculated experimentally from absorption spectra of the electrode active material (e.g., collected using UV/visible spectroscopy). As another example, the band gap may also be calculated computationally (e.g., using density functional theory).

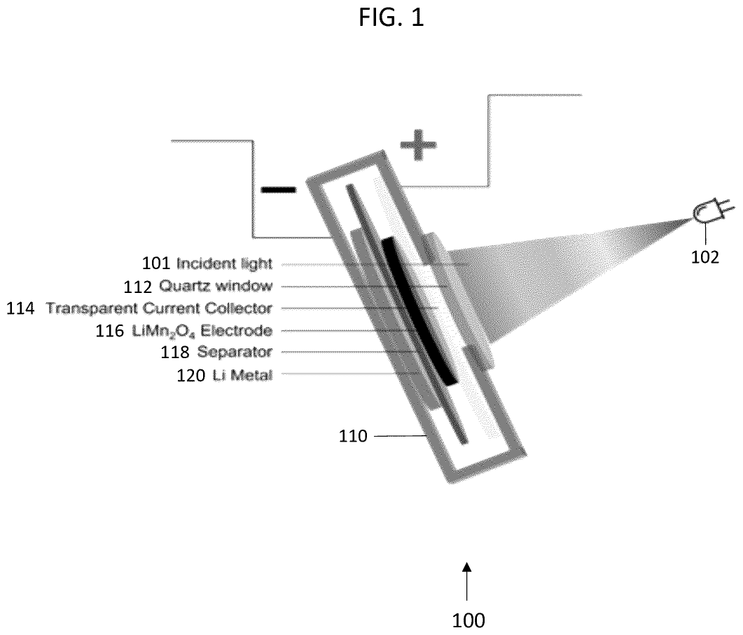

FIG. 1 is an illustration of a modified rechargeable battery coin cell 100 for photo-accelerated charging by irradiation of the cathode, according to an embodiment. The coin cell 100 includes a case 110 and a quartz window 112 sealed against the case 110 to hermetically seal the coin cell 100. The current collector 114 on the cathode side of the coin cell 100 is substantially transparent to the wavelength(s) of light used to irradiate the cathode. For example, the current collector 114 may be a polyethylene terephthalate (PET) substrate coated with indium tin oxide (ITO) or indium-doped tin oxide. In some embodiments, the current collector 114 includes a metal foil ring (e.g., an aluminum foil) between the PET coated ITO and the battery casing to improve the current collector's conductivity. During charging, light 101 from the illumination source 102 outside of the coin cell 100 can travel through the quartz window 112 and the transparent current collector 114 to irradiate the cathode 116 for photo-assisted charging. The cathode 116 (e.g., a spinel LiMn₂O₄ (LMO) electrode) and the anode 120 (e.g., a lithium metal electrode) are stacked together with a separator 118 in between the cathode 116 and the anode 120.

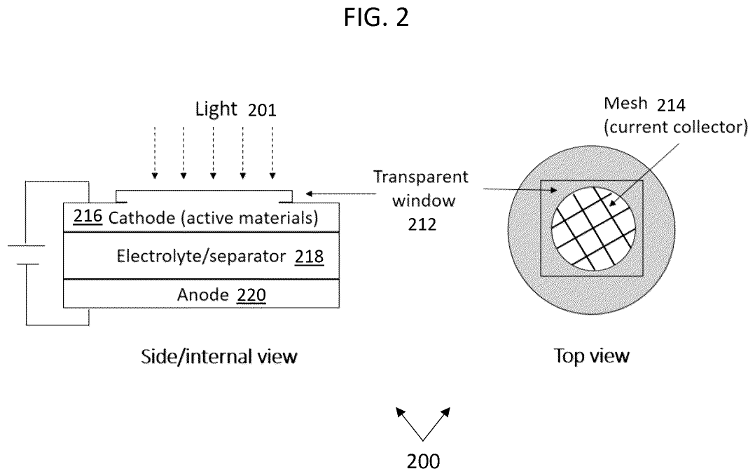

FIG. 2 is an illustration of another modified rechargeable battery coin cell 200 for photo-accelerated charging by irradiation of the cathode, according to an embodiment. The coin cell 200 includes a quartz window 112 sealed against a case to hermetically seal the coin cell 200. The current collector 214 on the cathode side of the coin cell 100 is mesh made of electrically conductive material (e.g., nickel, copper, or aluminum) so that it allows the passage of light used to irradiate the cathode. During charging, light 201 can travel through the quartz window 212 and the mesh current collector 214 to irradiate the cathode 216 for photo-assisted charging. The cathode 216 and an anode 220 are stacked together with a separator 218 in between the cathode 216 and the anode 220.

Similar embodiments of a battery for photo-accelerated charging may include a quartz window and a transparent or mesh current collector on the anode side to irradiate the anode. Similar embodiments may include quartz windows and transparent or mesh current collectors on both the cathode and anode side of the battery to irradiate both the anode and the cathode. For example, an aluminum mesh may be used as the current collector on the cathode side and a copper mesh may be used as the current collector on the anode side.

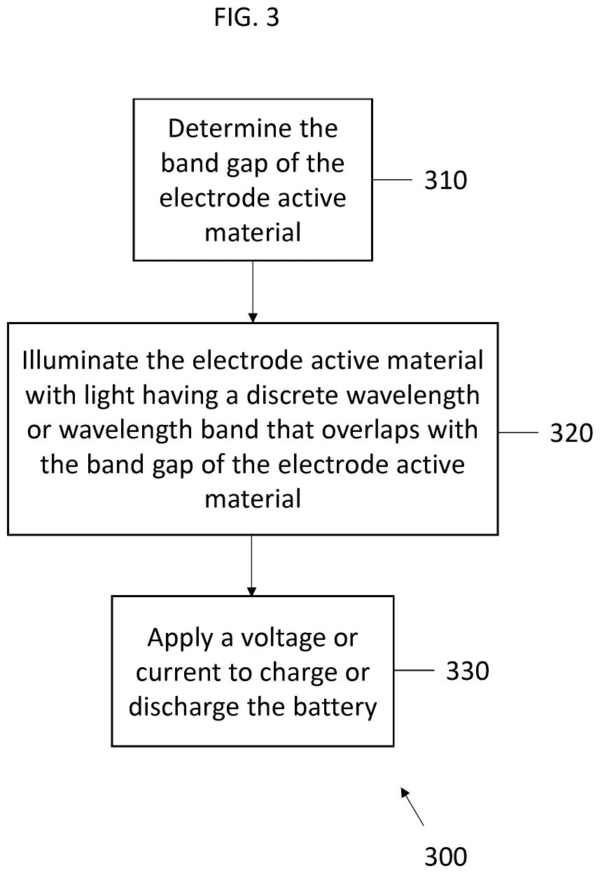

FIG. 3 is a flow chart of a process 300 for photo-assisted fast charging or discharging using light irradiation of one or both electrodes. In step 310, the band gap of the electrode active material is determined. In embodiments where the cathode is irradiated, the band gap of the cathode electrode active material is determined. In embodiments where the anode is irradiated, the band gap of the anode electrode active material is determined. In embodiments where both the cathode and the anode are irradiated, two band gaps are determined—that of the cathode electrode active material and the anode electrode active material. Each band gap may be determined by calculating the band gap using any reasonable experimental or computational methods. For example, the band gap of the electrode active material may be calculated experimentally from absorption spectra of the electrode active material (e.g., collected using UV/visible spectroscopy). As another example, the band gap may also be calculated computationally (e.g., using density functional theory).

In step 320, the battery electrode is illuminated with light having a discrete wavelength or wavelength band that overlaps with the band gap of the electrode active material. The wavelength band may be a narrow band of wavelengths. For example, the spectral width of the narrow band of wavelengths may be about 10 nanometers (nm) to about 100 nm (e.g., 10 nm, 20 nm, 30 nm, 40 nm, 50 nm, 60 nm, 70 nm, 80 nm, 90 nm, or 100 nm), or any value there between. The light may be in the ultraviolet (UV), visible, or near-infrared (IR) region of the light spectrum (i.e., having wavelengths of about 200 nm to about 1000 nm). For example, the light may be in the red region of the spectrum (i.e., having wavelengths of about 620 nm to about 750 nm). As another example, the light may be in the ultraviolet region of the spectrum (i.e., having wavelengths of about 315 nm to about 400 nm).

When both electrodes are illuminated, the light has two different discrete wavelengths or wavelength bands. In some cases, the two wavelength bands overlap and in other cases, the two wavelength bands do not overlap. The two wavelength bands may be spatially separated so that all or a large portion of light at wavelengths corresponding to the cathode is directed toward the cathode and all or a large portion of light at wavelengths corresponding to the anode is directed toward the anode. In some cases, two different illumination sources are employed, each illumination source producing light at wavelengths corresponding to only one of the electrodes. In some cases, one illumination source produces light and filters are used to select the wavelength bands corresponding to particular electrodes.

In step 330, a voltage and/or current is applied to the battery to charge/recharge or discharge the battery. The voltage and/or current applied may have any value reasonable for the electrode materials. The battery may be charged or discharged at a constant voltage. For example, a lithium-ion battery may be charged at a constant voltage of about 3.8 volts (V) to about 4.2 V (e.g., 4.07 V). The battery may be charged at a constant current. For example, the constant current may have a C-rate of about 0.1 C to about 30 C (e.g., 0.5C, 1C, 2 C, 5 C, 10 C, 20 C, or 30 C). The battery may be discharged at a constant voltage of about 1 V to about 2.5 V. The battery may be discharged at a constant current. For example, the constant current may have C-rate of about 0.1 C to about 30 C (e.g., 0.1 C, 0.5C, 1C, 2 C, 5 C, 10 C, 20 C, or 30 C).

Steps 320 and 330 may occur simultaneously or may substantially overlap. In some cases, the step of illumination 320 is started before the step of charging/discharging 330 and the step of illumination 320 is stopped after the step of charging/discharging 330 is stopped. In some cases, the step of charging/discharging 330 is started before the step of illumination 320 and the step of charging/discharging 330 is stopped after the step of illumination 320 is stopped.

The illumination source may be any source that may provide light to the electrode or electrodes of the electrochemical cell during charging. For example, the illumination source may be external to the electrochemical cell and used in conjunction with an optical window located in a housing for the electrochemical cell, such that the illumination light source may be used to direct light through the window to the cathode. The window may be a plastic, quartz, glass, BaF₂, or other material that will allow for the passage of the light without substantial absorption in the wavelength of interest.

The illumination source may be a light emitting diode (LED) source. During a charging and/or discharging cycle the LED may be automatically turned on to illuminate the electrode. In some embodiments, the LED can be located inside the electrochemical cell near the electrode that is irradiated during charging such that the housing of the electrochemical cell does not need a window or port. In other embodiments, the LED can be located external to the electrochemical cell and light from the LED may pass through a window in the housing of the electrochemical cell toward the electrode during charging. When both electrodes in the electrochemical cell are irradiated during charging, a single LED may be used to irradiate both electrodes, or two different LEDs may be used to each irradiate a different electrode. A single LED may be used, or an array of LEDs may be used, depending on the desired light intensity.

In some embodiments, the illumination source may be an optical fiber paired with a light source (e.g., an LED). That is, the optical fiber can deliver light from the light source to the electrochemical cell. The optical fiber may be used to direct light through a window located in a housing for the electrochemical cell, or may be used to direct light directly into the cell through an optical fiber port in the housing of the electrochemical cell.

As noted above, the electrochemical cell contains a non-aqueous electrolyte and is thus a non-aqueous electrochemical cell. This thus may include other non-aqueous cells, but is not limited to a lithium ion battery; thus a sodium ion battery, a magnesium ion battery, lithium air or a lithium sulfur battery are envisioned whereby these chemistries interact positively with light to allow faster recharging.

In some embodiments, the electrode active material illuminated for photo-accelerated charging and/or discharging has t_{2g} and e_{g} electronic states above the Fermi level in the ultraviolet, visible, or near-infrared range of light. In some embodiments, the electrode active material has t_{2g} and e_{g} electronic states above the Fermi level in the visible range of light. Electronic transitions between t_{2g} and e_{g} (from t_{2g} to e_{g} or vice versa depending on the electronic structure of the material) above the Fermi level in the electrode active material induced by photon absorption due to illumination of the electrode material with narrowband light may provide photo-accelerated charging. As examples of suitable cathode active materials, LMO has Mn-t_{2g} to Mn-e_{g} transitions at about 620 nm and about 775 nm and LiCoO₂ has t_{2g}-e_{g} transitions possible at about 300 nm and about 600 nm. As an example of an anode active material, Li₄Ti₅O₁₂ is a spinel anode with Ti d states (both t_{2g} and e_{g}) above the fermi level in the ultraviolet light range. Any of these electronic transitions may be used for photo-accelerated charging.

The cathode may include an active material that is photo-active with a wide bandgap. The cathode active material may be a ceramic or a semiconductor. In some embodiments, the cathode active materials have band gaps ranging from approximately 1.3 eV to 4 eV. The band gap of LiMn₂O₄ spinel (LMO) in its fully discharged state is 1.99 eV. It stands to reason that the band gap increases as the material is delithiated to lambda-MnO₂ spinel with a band gap of 2.3 eV. Thus Red LED light energy matches that of the LMO and delithiated LMO material.

Illustrative cathode active materials may include, but are not limited to, a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ′}O_{2-z″}F_{z″}, or VO₂. In the cathode active materials, M⁴ is Al, Mg, Ti, B, Ga, Si, Mn, or Co; M⁵ is Mg, Zn, Al, Ga, B, Zr, or Ti; A is Li, Ag, Cu, Na, Mn, Fe, Co, Ni, Cu, or Zn; B¹ is Ti, V, Cr, Fe, or Zr; 0≤x≤ 0.3; 0≤y≤0.5; 0≤z≤0.5; 0≤x″≤0.4; 0≤α≤1; 0≤β≤1; 0≤γ≤1; 0≤δ′≤0.4; 0≤z″≤0.4; and 0≤n′≤3; with the proviso that at least one of α, β and γ is greater than 0. In some embodiments, the cathode includes LiFePO₄, LiCoO₂, LiNiO₂, LiNi₁₋ₓCo_{y}M⁴_{z}O₂, LiMn_{0.5}Ni_{0.5}O_{0.5}O₂, LiMn_{1/3}C_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCoMnO₄, LiCoMnO₄, LiNi_{0.5}Mn_{1.5}O₄, LiNiPO₄, LiCoPO₄, LiMnPO₄, LiCOPO₄F, Li₂MnO₃, Li₅FeO₄, and Li_{x′}(Met) O₂, wherein Met is a transition metal and 1<x′≤2. In some embodiments, Met is Ni, Co, Mn, or a mixture of any two or more thereof. In some embodiments, Met is a mixture of Ni, Co, and Mn. In some embodiments, the cathode active material may include LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiCr_{0.5}Mn_{1.5}O₄, LiCrMnO₄, LiFe_{0.5}Mn_{1.5}O₄, LiCo_{0.5}Mn_{1.5}O₄, LiCOMnO₄, LiCOMnO₄, LiNi_{0.5}Mn_{1.5}O₄, LiNiPO₄, LiCOPO₄, LiMnPO₄, LiCoPO₄F, Li₂MnO₃, Li₅FeO₄, or Li_{x′}(Met)O₂, where Met is a transition metal and 1<x′≤2. Other materials may include metallic or semiconducting particles, or plasmonic particles that create nascent electric fields when irradiated by white light.

In some embodiments, the cathode may include a cathode active material that includes manganese. In such embodiments, the cathode active material may include, but is not limited to LiMn_{0.5}Ni_{0.5}O₂, LiMn_{1/3}Co_{1/3}Ni_{1/3}O₂, LiMn_{0.3}Co_{0.2}Ni_{0.5}O₂, LiNiₓMn_{y}O₂ where 0<x≤0.95 and x+y equals 1, LiMn₂O₄, LiMn⁴_{0.5}O₄, Li_{1-x′}Ni_{α}Mn₆₂ Co_{γ}M⁵_{δ′}O_{2-z″}F_{z″}, LiMn_{0.5}Ni_{0.5}O₂, LiMn_{1/3}Co_{1/3}Ni_{1/3}O₂, LiMn_{0.2}Co_{0.2}Ni_{0.6}O₂, LiMn0.1Co₀₁Ni_{0.8}O₂, LiMn₂O₄, LiCr_{0.5}Mn_{1.5}O₄, LiCrMnO₄, LiFe_{0.5}Mn_{1.5}O₄, LiCO_{0.5}Mn_{1.5}O₄, LiCoMnO₄, LiCoMnO₄, LiNi_{0.5}Mn_{1.5}O₄, LiMnPO₄, LiNiPO₄, LiCOPO₄, or Li₂MnO₃, LiCoPO₄F, Li₂MnO₃, Li₅FeO₄, or Li_{x′}(Met)O₂, Met is a transition metal and 1<x′≤2, and where M⁴ is Al, Mg, Ti, B, Ga, Si, Mn, or Co; M⁵ is Mg, Zn, Al, Ga, B, Zr, or Ti; 0≤x″≤0.4; 0≤α≤1; 0≤β≤1; 0≤γ≤1; 0≤δ′≤0.4; 0≤z″≤0.4; and 0≤n′≤3.

In some embodiments, the cathode may include a cathode active material that includes a disordered rock salt Li₁₊ₓMO_{2+δ} where M is Mg, Zn, Al, Ti, a transition metal, or any combination of two or more thereof; a disordered layered Li₁₊ₓMO_{2+δ} where M is Mg, Zn, Al, Ti, a transition metal, or any combination of two or more thereof; a disordered spinel cathode material; a layered-spinel cathode material; a layered-layered-spinel cathode material; a DRX composite; an intergrowth of any two or more thereof; or any combination of two or more thereof.

In additional embodiments, the cathode or cathode active material may consist of disordered rock salt cathodes (so called ‘DRX’), disordered layered Li₁₊ₓMO_{2+δ} cathodes, and disordered spinel cathodes, and composites thereof. Cathode materials that have low electrical and Li ionic conductivity all benefit from photo-assisted light charging which assists in speeding up transport properties in cathode oxides.

The anode may include an active material that is photo-active with a wide bandgap. The anode active material may be a ceramic or a semiconductor. In some embodiments, the anode active materials have band gaps ranging from approximately 1.3 eV to 4 eV. Some embodiments include photo-active electrode materials in anodes and cathodes, while other embodiments include photo-active electrode materials in only one of the anode or cathode of the battery. For graphite, the band gap begins as zero, but as it is charged the bandgap increase and for fully lithiated LiC₆ (372 mAh/g) it is approximately 2 eV, thus demonstrating charge transfer between the Li and the graphite hexagonal planes. With a value of 2 eV, that energy of the band gap is commensurate with the light energy of UV light, and thus would be excited by UV light intensity on the material.

The anode includes metallic anode active materials such as lithium, sodium, or magnesium; sulfur materials; metal oxides such as TiO₂ or Li₄Ti₅O₁₂; or carbon materials including, but not limited to, synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, or graphene. In any of the above embodiments, the anode may include a graphite material, alloys, intermetallics, silicon, silicon oxides, TiO₂ and Li₄Ti₅O₁₂, and composites thereof. For example, the anode active material may include a metallic anode material intercalated within a host material, where the metallic anode material includes, but is not limited to, lithium, sodium, or magnesium, and the host material may be an active carbon material including, but not limited to, synthetic graphite, natural graphite, amorphous carbon, hard carbon, soft carbon, acetylene black, mesocarbon microbeads (MCMB), carbon black, Ketjen® black, mesoporous carbon, porous carbon matrix, carbon nanotube, carbon nanofiber, or graphene. In other embodiments, the metallic anode material includes, but is not limited to, lithium, sodium, or magnesium, and the host material may be an alloy, intermetallic, silicon, silicon oxide, TiO₂, Li₄Ti₅O₁₂, or mixtures of any two or more thereof. In some embodiments, the anode active material is a lithiated carbon material such as lithiated graphite.

To balance the electrodes and eliminate or substantially reduce the effect of lithium plating on the anode, a slightly larger than 1 N/P ratio may be chosen. The N/P ratio is the ratio of anode capacity to cathode capacity. The N/P ratio may be about 1.0 to about 1.5. For example, the N/P ratio may be about 1.1, 1.19, 1.21, or 1.35.

The cathodes and/or anodes of the lithium ion cells may also include a current collector. Current collectors for the anode and/or the cathode may include those of indium-doped tin oxide, PET with indium-doped tin oxide, nickel, copper, stainless steel, titanium, tantalum, platinum, gold, aluminum, nickel, cobalt nickel alloy, highly alloyed ferritic stainless steel containing molybdenum and chromium, or nickel-, chromium-, or molybdenum-containing alloys. The current collector may be a solid foil, a solid foam, or a solid mesh, depending on the transparency of the material and whether the current collector's electrode is illuminated. In some embodiments, the current collector additionally includes a ring of conductive foil to increase conductivity between the current collector and the battery casing.

The anodes and cathodes may include a binder that holds the active material and other materials in the electrode to the current collector. Illustrative binders include, but are not limited to, polyvinylidene difluoride (PVDF), polyvinyl alcohol (PVA), polyethylene, polystyrene, polyethylene oxide, polytetrafluoroethylene (Teflon), polyacrylonitrile, polyimide, styrene butadiene rubber (SBR), carboxy methyl cellulose (CMC), alginate, gelatin, a copolymer of any two or more such polymers, or a blend of any two or more such polymers.

The electrochemical cells may also include a separator between the cathode and anode to prevent shorting of the cell. Suitable separators include those such as, but not limited to, a microporous polymer film that is nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Commercially available separators include those such as, but not limited to, Celgard® 2025 and 3501, Tonen separators, and ceramic-coated separators.

The non-aqueous electrolyte may include a non-aqueous solvent and a salt. Illustrative non-aqueous solvents include, but are not limited to, silanes, siloxanes, ethylene carbonate, dimethylcarbonate, diethylcarbonate, propylene carbonate, dioloxane, γ-butyrolactone, γ-butyrolactone, dimethyl ether, a silane, siloxane N-methyl acetamide, acetonitrile, an acetal, a ketal, esters, a carbonates, a sulfone, a sulfite, sulfolane, an aliphatic ether, a cyclic ether, a glyme, a polyether, a phosphate ester, a siloxane, a N-alkylpyrrolidone, fluoro ether and fluoro esters, fluoroethylene carbonate, or adiponitrile, or a fluorinated solvent. Illustrative fluorinated solvents include those represented by Formula I, II, III, or IV:

R¹—O—R² Formula I

R¹—C(O)O—R² Formula II

R¹—-OC(O)O—R² Formula III

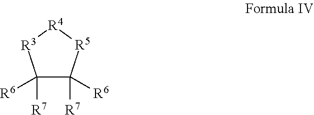

R¹—S(OO)—R² Formula V

In Formulas I, II, III, IV, and V, R¹ and R² are individually an alkyl or CₐH_{b}F_{c} group; R³ and R⁵ are individually O or CR⁶R⁷; R⁴ is O or C═O; each R⁶ and R⁷ is individually H, F or a CₐH_{b}F_{c} group; each b is individually from 0 to 2a; each c is individually from 1 to 2a+1; and each a is individually an integer from 1 to 20. However, the formulae are also subject to the following provisos: at least one of R¹ and R² is a CₐH_{b}F_{c} group; at least one R⁶ or R⁷ is other than H, and R⁴ is not O when R³ or R⁵ is O. In some embodiments, R¹ and R² are individually CF₂CF₃; CF₂CHF₂; CF₂CH₂F; CF₂CH₃; CF₂CF₂CF₃; CF₂CF₂CHF₂; CF₂CF₂CH₂F; CF₂CF₂CH₃; CF₂CF₂CF₂CF₃; CF₂CF₂CF₂CHF₂; CF₂CF₂CF₂CH₂F; CF₂CF₂CF₂CH₃; CF₂CF₂CF₂CF₂CF₃; CF₂CF₂CF₂CF₂CHF₂; CF₂CF₂CF₂CF₂CH₂F; CF₂CF₂CF₂CF₂C_{H}3; or CF₂CF₂OCF₃. In some embodiments, the fluorinated solvent includes CHF₂CF₂OCF₂CF₂CF₂H;

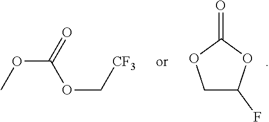

As noted, the non-aqueous electrolyte may include a non-aqueous solvent and a salt. The salt may be a salt as known for use in a lithium ion, sodium ion, magnesium ion, or other battery. For example, the salt may be a lithium salt. Suitable lithium salts include, but are not limited to, LiBr, LiI, LiSCN, LiBF₄, LiAlF₄, LiPF₆, LiAsF₆, LiClO₄, Li₂SO₄, LiB(Ph)₄, LiAlO₂, Li[N(FSO₂)₂], Li[SO₃CH₃], Li[BF₃(C₂F₅)], Li[PF₃(CF₂CF₃)₃], Li[B(C₂O₄)₂], Li[B(C₂O₄)F₂], Li[PF₄(C₂O₄)], Li[PF₂(C₂O₄)₂], Li[CF₃CO₂], Li[C₂F₅CO₂], Li[N(CF₃SO₂)₂], Li[C(SO₂CF₃)₃], Li[N(C₂F₅SO₂)₂], Li[CF₃SO₃], Li₂B₁₂X₁₂₋ₙHₙ, Li₂B₁₀X_{10-n′}H_{n′}, Li₂S_{x″}, (LiS_{x″}R¹)_{y}, (LiSe_{x″}R¹)_{y}, and lithium alkyl fluorophosphates; where X is a halogen, n is an integer from 0 to 12, n′ is an integer from 0 to 10, x″ is an integer from 1 to 20, y is an integer from 1 to 3, and R¹ is H, alkyl, alkenyl, aryl, ether, F, CF₃, COCF₃, SO₂CF₃, or SO₂F. In any of the above embodiments, the salt includes Li[B(C₂O₄)₂], Li[B(C₂O₄)F₂], LiClO₄, LiBF₄, LiAsF₆, LiPF₆, LiCF₃SO₃, Li[N(CF₃SO₂)₂], Li[C(CF₃SO₂)₃], Li[N(SO₂C₂F₅)₂], or a lithium alkyl fluorophosphate.

In another aspect, a process is providing for charging a discharged electrochemical cell, the electrochemical cell being any of those as described above in any embodiment. The process includes applying a voltage bias to the discharged electrochemical cell; and illuminating one or both electrodes with a light source at a discrete wavelength band corresponding to the band gaps of the one or both electrodes. The discharged electrochemical cell comprises a cathode, an anode, and a non-aqueous electrolyte. The illumination source may be a light emitting diode or a laser providing light that may pass through a window in a housing of the electrochemical cell.

In the process, the illumination source may be a light source. The light source may, in some embodiments be a broadband white light source filtered to a narrowband light before it reaches the electrode. For example, the illumination source may be the sun or an electric discharge lamp (e.g., a xenon arc lamp) with a light filter. In other embodiments, the light source may be an electroluminescent light source having a narrowband light emission (e.g., a light-emitting diode, organic light-emitting diode, or laser. In some cases, a filter may be employed with the electroluminescent light source to further narrow the wavelength band. In the process, the electrochemical cell may be a lithium ion battery, a sodium ion battery, a magnesium ion battery, or a sulfur battery. The use of the illumination source for the one or two electrodes may result in a reduction in charging time. In some embodiments, the reduction is a 10% reduction in charging time compared to a cell without the illumination source. This includes charging time reductions of 15%, 20%, 25%, 30%, 35%, 40%, 45%, 50%, 55%, 60%, 65%, 70%, 75%, or 80%, or more. In some embodiments, the reduction in charging time is a 25% reduction in charging time compared to a cell without the illumination source. In some embodiments, the reduction in charging time is a 50% reduction in charging time compared to a cell without the illumination source. In some embodiments, the reduction in charging time is a 75% reduction in charging time compared to a cell without the illumination source. In some embodiments, the reduction in charging time is a 25-75% reduction in charging time compared to a cell without the illumination source.

Also disclosed herein are light stations that may be used in conjunction with electrical charging stations for recharging electric vehicles or hybrid electric vehicles. For example, existing gas stations, rest areas, or other roadway stations employ light stations using existing electrical infrastructure at their locations to provide power to the illumination source for photo-accelerated charging processes or hybrid or electric vehicle batteries.

The present invention, thus generally described, will be understood more readily by reference to the following examples, which are provided by way of illustration and are not intended to be limiting of the present invention.

### EXAMPLES

### Example 1

Spinel LiMn₂O₄ (LMO) is of particular interest for high current applications because it has a three-dimensional network available for relatively unhindered Li⁺ diffusion, leading to fast lithiation/delithiation kinetics. The effect of discrete wavelengths of light on the electrochemical performance of the LMO cathode in voltage holds or dynamic charging processes in a Li-ion battery was investigated. Illuminating with red light (2.0 eV) resulted in a higher charging rate compared to ultraviolet (3.2 eV) illumination of equal optical power and dark conditions. The selective effectiveness of red light in enhancing electrochemical kinetics was analyzed in the context of the electronic structure and possible excitations, revealing the importance of d-d orbital electronic transitions in Mn. These conclusions were correlated with X-ray absorption spectroscopy (XAS) data, which unveiled that the cubic crystal lattice shrunk under red light and the magnitude of the change, manifested in reduction of Mn-Mn bond length, was a function of the electrode state-of-charge (SOC).

### Results and Discussion.

Optically driven electronic transitions are often associated with low energy processes where electrons are moved from ground state to an excited state. This absorption of light results in the visible appearance of color. For demonstration of fundamental light interactions with LMO, semi-transparent thin-films were prepared by a sol-gel method. X-ray diffraction data shown in confirmed the cubic spinel structure.

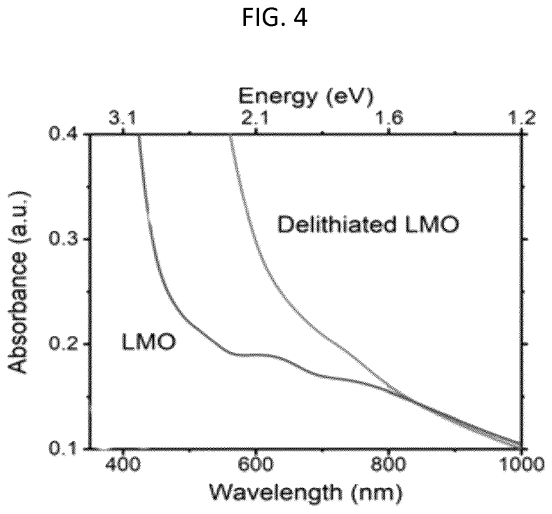

FIG. 4 is a UV/Vis (ultraviolet/visible) absorption spectra of a thin film LMO (spinel LiMn₂O₄), and a chemically delithiated LMO. LMO in its fully lithiated pristine state (LiMn₂O₄) appeared green and exhibited absorption at several regions in the visible spectrum.

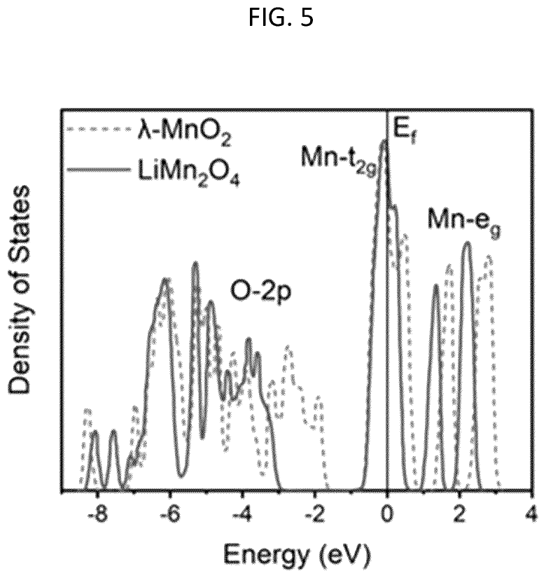

FIG. 5 is a graph of the density of states of LMO and λ-MnO₂. Not all light absorption processes take place in the same manner. This can be observed when comparing the UV/Vis absorption spectrum of LMO with the density of states, where the intense absorption in the UV region is a result of electronic transitions from the O-2p to the Mn-t_{2g} states. There are also two peaks centered at about 620 nm and about 775 nm representing the Mn-t_{hd 2g} to Mn-e_{g} transitions, which are split as a result of the Mn d-orbital Jahn-Teller distortion. There is non-zero absorption at lower energy than 775 nm as a result of intraband transitions because the Fermi level is positioned within the t_{2g} band. Interestingly, upon chemical delithiation by treatment with 1 molar (M) H₂SO₄, the O-2p band shifted towards the Fermi level, resulting in a redshift in the O-2p peak, and a change in color of LMO was observed, in agreement with the calculated density of states. The change in color indicated a change in the electronic ground and excited state of the delithiated LMO. Without being bound by any theory, it is thought that these changes in ground and excited state energy levels which occur among the various amounts (composition) of Li in the LMO that modulate the d-d electronic transitions. Delithiation of LMO results in shifting of the O-2p band closer to the Fermi level, while raising the Mn-e_{g} bands higher in energy. The electronic structure upon delithiation results in a redshift in the high intensity O-2p to Mn-t_{2g} absorption peak, so that it overlaps and obscures the blueshift of the Mn-t_{2g} to Mn-e_{g} peaks.

To evaluate the effect of LED light illumination on LMO during charging, a windowed coin cell was developed, as described above. Indium tin oxide (ITO) coated on a polyethylene terephthalate (PET) substrate was used as a transparent current collector for electrode laminates. ITO/PET was chosen as the transparent current collector for its high visible transmittance and electrochemical stability at cathodic voltages in lithium ion batteries, and for ITO's negligible photoresponse. LMO-containing binder and carbon slurries were then coated onto the transparent current collector and, upon drying, were punched into 15 mm discs. An outer ring was scraped from the electrode discs, leaving behind an 11 mm diameter cathode with an edge-deleted outer ring of exposed current collector. An aluminum foil annulus with inner diameter of 11 mm and outer diameter 18 mm was placed on the edge-deleted electrode disc such that electrical contact could be made to the coin cell case. LMO half cells were assembled with an 8 mm hole drilled from the coin cell case allowing direct illumination of the LMO electrode through the transparent current collector. To insulate the cell from the atmosphere while allowing illumination of the electrode, a quartz window was sealed onto the coin cell case using electrolyte stable epoxy. The cell was sealed from the atmosphere because, among other things, humid air is detrimental to lithium ion battery electrolyte performance.

Windowed coin cells performed reliably in galvanostatic cycling, showing no signs of water ingress into the cell. Cells using ITO current collectors showed specific capacity in galvanostatic cycling about 6% lower than those of cells with a standard opaque aluminum foil current collector, which, without being bound by any theory, may be due to the higher in-plane electrical resistance of the ITO compared with that of the Al. Even with its higher in-plane electrical resistance, ITO is still a suitable material for the current collectors in these batteries. No apparent electrochemical degradation or significant capacity fade of the cells was observed using ITO over the course of 10 cycles. To test the electrochemistry under illumination, windowed coin cells were illuminated with LEDs mounted 20 cm from the surface of the cell. In order to probe the kinetics of delithiation most directly upon illumination, batteries were held at a constant voltage and the current was allowed to fluctuate. The LEDs were allowed to illuminate the cell for 5 minutes (min), at which point a constant voltage of 4.07 V was applied across the coin cell for 20 min, while maintaining illumination. 4.07 V was chosen because it corresponds to the high slope region in the center of the charging curve. In chronoamperometry in batteries, holding voltage in a high slope region allows for reproducible targeting of the same state of charge, unlike in a plateau, where a small change in applied voltage may have a large impact on current response. Holding at the top end of the voltage window however may result in abusive cycling conditions (very high current, large temperature changes), which can quickly degrade the battery, so 4.07 V is a favorable region to get reliable electrochemical data. There was no significant negative impact to the electrolyte performance as a result of illumination. Optical power for each LED at the surface of the cell was adjusted to be equal to 180 mW cm⁻² by calibration of the LED driving current. During experiments, temperature was monitored, and cells were cooled by compressed air to prevent temperature changes due to light irradiation. Because the temperature only changed by about 1.5° C. from ambient, the temperature changes during illumination did not significantly affect electrochemical results.

TABLE 1
Performance data of photo-accelerated fast
charging in LMO.

| | Dark | UV Light | Red Light |
|---|---|---|---|
| Charge Capacity (mAh g⁻¹) | 18.14 | 18.16 | 20.69 |
| Discharge Capacity (mAh g⁻¹) | 17.54 | 17.59 | 20.03 |
| Coulombic efficiency (%) | 96.7 | 96.9 | 96.8 |

Electrochemical performance of LMO windowed cells under illumination.

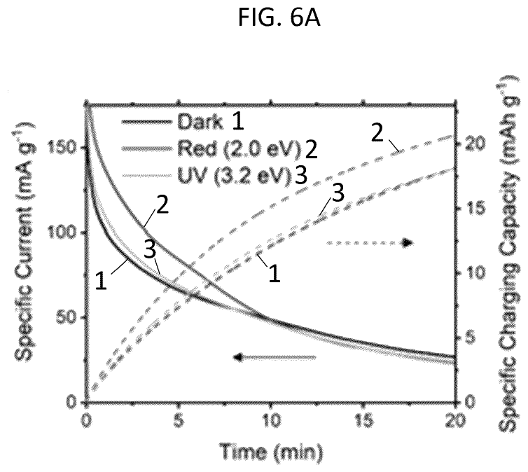

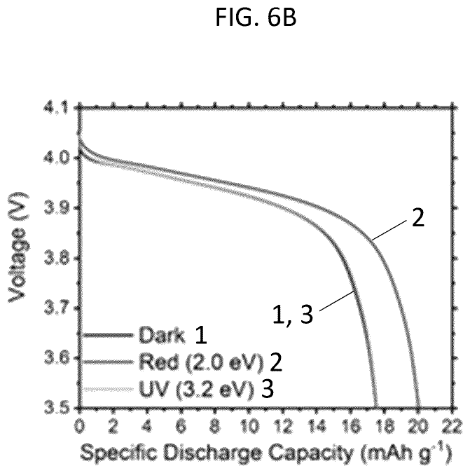

The chronoamperometry and chronocoulometry results are shown in FIG. 6A, along with subsequent galvanostatic discharge (in dark) after the voltage hold in FIG. 6C. As shown above in Table 1, illumination with red light resulted in a 14% higher charging capacity during the 20 min period as compared to dark, whereas UV light illumination resulted in no change from the dark. The discharge capacity followed the same trend with a nearly identical coulombic efficiency across all three measurements. Because the current under red light was higher at earlier times, the current may have decreased faster as the electrode equilibrated to the held voltage faster. Thus, at about 10 minutes, the charging current under red light resulted in similar current, though at a higher state of charge (SOC). Since the same cell was compared, the total capacity was unchanged. Under red light, a higher capacity was reached in 20 minutes, a relevant timescale for commercial fast charging. An additional indication of increased charging rate was the higher slope in the chronocoulometry curves at early times in FIG. 6A. In the linear portion of the chronocoulometry curve (chosen to be the first 4 min) red light illumination resulted in a curve with 33% higher slope than the cell not illuminated (“dark”), whereas the cell illuminated with UV light was only 7% higher than the dark cell. Holding the voltage at a constant 4.07 V allowed the current to fluctuate uninterrupted, thus reflecting, indirectly, the resistance of the battery. Electrochemical impedance spectroscopy (EIS) results shown in indicated that cell impedance was significantly reduced under red light illumination compared to illumination with UV light, in agreement with the chronoamperometry results. A lower battery resistance, regardless of the electrochemical reaction at play results in faster charging.

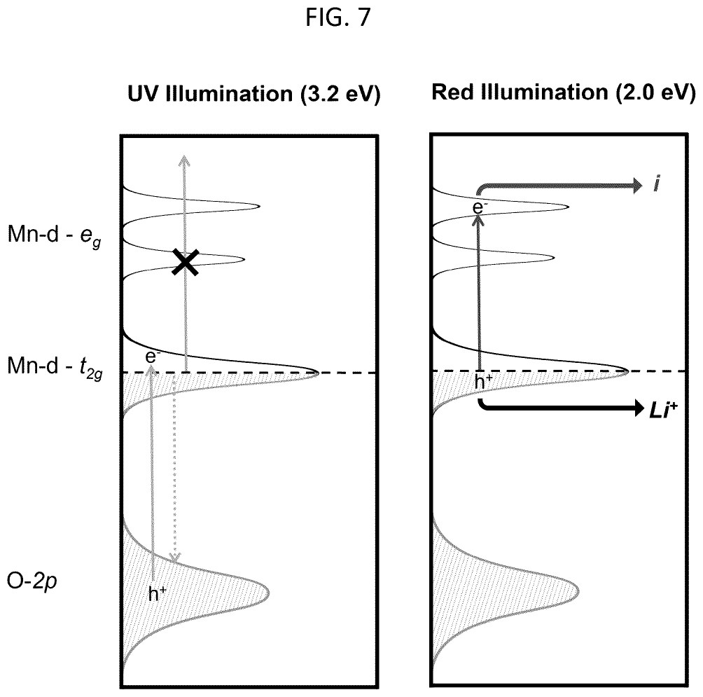

Without being bound by any theory, when the electrochemical performance of the red-light illuminated cell was considered alongside the LMO density of states (FIG. 5), it is apparent that red light may promote an electron from around the Fermi level in the energetically lower Mn-t_{2g} states to higher energy Mn-e_{g} states, with 2 discrete bands beginning ˜1.0 eV and ˜2.0 eV above the Fermi level (shown schematically in FIG. 7). Accordingly, as the potential energy barrier for charge transfer is reduced, Mn is preferentially oxidized leading to lower resistance and, in turn, improved Li-ion conductivity. The barrier to Li ejection from the crystal lattice is in response to the charge transfer process. Note that the cubic lattice of LMO does not discriminate to isotropic Li-diffusion within any crystal facet under light irradiation. Since the Mn-t_{2g} to Mn-e_{g} transition shifts to higher energy at higher SOC, it may be possible to tune photo-acceleration wavelengths during the course of the charge. However, since the O-2p to Mn-t_{2g} transition has a higher absorption cross-section (FIG. 4), it may require doping to modify the electronic structure to reduce the energy of the O-2p band.

Conversely, without being bound by any theory, because there are no available electronic states 3.2 eV above the Fermi level, the UV light may not promote an electron from a Mn-t_{2g} state to any Mn-e_{g} state. Instead, the only possible excitation may be from an O-2p state into an unoccupied Mn-t_{2g} state. This lack of d-d orbital interaction/excitation when UV light is applied to the electrode may be the reason for the lack of electrochemical performance enhancement with UV light. As a result, red light is more favorable for inducing photo-accelerated charging in LMO, despite its lower energy when compared to UV.

A non-gated (non-pulsed) optical light pump-X-ray structural probe experiment (X-ray absorption spectroscopy; XAS) was employed to determine the effect that light illumination has on the LMO crystal lattice. While lithium cations were not moved around in the structure under an electrical circuit in this ex-situ X-ray experiment, the structural displacement of atoms as a result of their interaction and absorption of light energy was measured, and a priori, the cross-section of electron excitation of Mn-t_{2g} to Mn-e_{g} transitions within the MnO₆ octahedra of LMO. LMO electrodes extracted from coin cells were analyzed using X-ray absorption fine structure (XAFS) and X-ray absorption near edge structure (XANES). Data was collected first in the dark, and then electrodes were illuminated continuously with LED light during data acquisition. Samples were in a state of either 0%, 33%, 67%, or 100% state-of-charge (SOC). At 0% SOC, there was a nominally equal amount of Mn (III) and Mn (IV) present in the electrode. As SOC increased, the ratio of Mn (III) to Mn(IV) decreased until there was no Mn(III) present, resulting in λ-MnO₂ upon full delithiation. Thus, conducting XAS with varied SOC with and without illumination made it possible to (1) examine the impact of average Mn oxidation state on localized LMO structural changes, and (2) determine the role that excited state electron population into higher energy Mn-e_{g} orbitals has on the Jahn-Teller distortion of ideal MnO₆ octahedral species (i.e. symmetrical d³ Mn⁴⁺ motif).

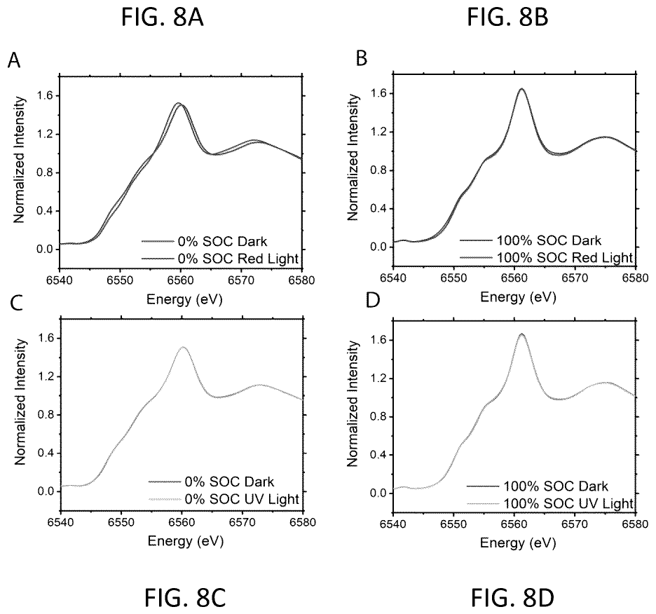

There was a blueshift of the Mn K-edge absorption maximum in XANES spectra of LMO electrodes at 0% SOC under red light illumination as compared to dark, indicating the presence of a photo-excited state (FIG. 8A). The magnitude of this shift decreased as SOC increased, resulting in no clear shift at 100% SOC (FIG. 8B). Contrary to red light, UV illumination did not provoke a XANES shift, indicating there was no such excitation (FIG. 8C, 8D). Further, the two shoulders at 6550 eV and 6553 eV both had an increased intensity, which, without being bound by any theory, may be related to Jahn-Teller distortion in LMO changes to the populated electronic states around Mn, leading to stabilization of the Mn 4p_{z} orbital. Since XAS in transmission mode is a bulk measurement, and penetration of red light into black mass electrode laminate LMO is limited to a few um based on the extinction coefficient of LMO at 623 nm, it is possible that the change in excited state population at the surface of the electrode is significant enough to result in a noticeable bulk property change, or excited Mn sites redistribute through the bulk of the electrode during constant illumination. Either process results in the crystal lattice contracting in response to photo-oxidized metal centers, and electron-populated Mn-e_{g} d-orbitals as discussed next.

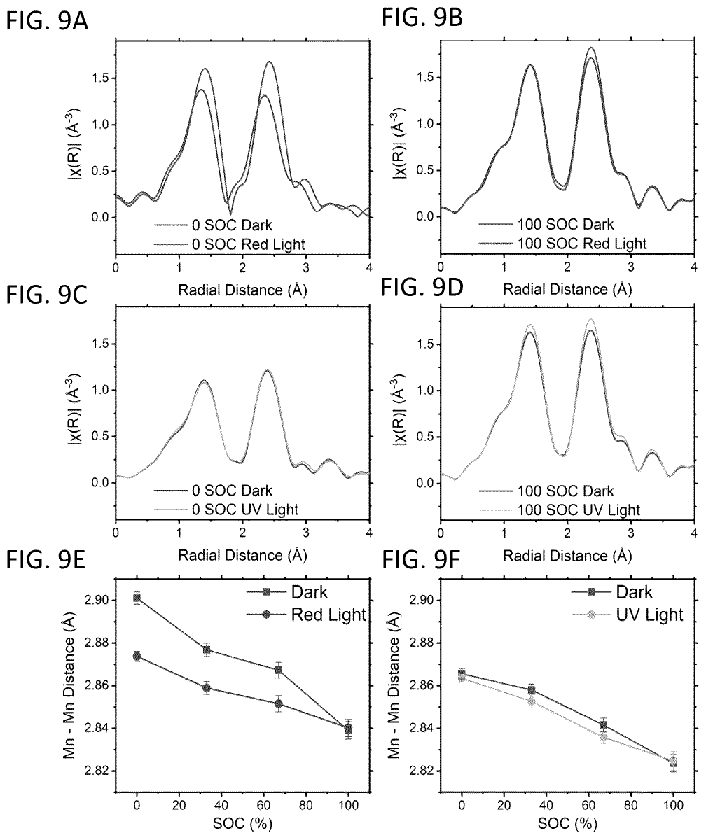

In addition to XANES, XAFS provides detailed information about the Mn interatomic distances and coordination environment. XAFS spectra indicated a clear shift to smaller R (distance to neighboring atom) in the Mn-O (1^{st} shell) and Mn-Mn (2^{nd} shell) peaks during illumination with red light (0% and 100% SOC shown in FIGS. 9A to 9F). As in XANES, the magnitude of the second shell shift was reduced as SOC increased, indicating a strong dependence on Mn d-electrons for excitation. When considered along with the density of states of LMO, illuminating LMO with red light may cause a local structure change as a result of Mn d-electron excitation, in agreement with the observed electrochemistry in red light. UV light, however, did not result in a shift in XAFS peaks at any SOC, indicating that the Mn-t_{2g} excitation may be the driving force for XAFS peak shift.

Fitting of the XAFS data revealed that Mn-Mn interatomic distance shrunk with illumination with red light, and as observed in the spectra, the magnitude of the change was reduced as SOC increased (FIG. 9E, 9F). As a result of the lattice geometry, Mn-O interatomic distance may not change as dramatically as Mn-Mn, though there are some small changes. Under UV illumination, the Mn-Mn distance was not significantly different than in the dark, in further agreement with the electrochemical data in FIG. 6A. Thus, the structural change driven by photoexcitation in red light manifested as a shrinkage of the crystal lattice. Since the observed shrinkage was a function of Mn oxidation state, it is possible that excitation of Mn d-electrons contributes to photo-accelerated fast charging by way of structural deformation in the spinel. Different spots on the sample were measured for UV and red LED experiments.

The photo-accelerated charging may be further increased through use of dopants to enhance probability of certain transitions, or combination of wavelengths to impact multiple states of charge. As the state of charge increased, the energy of the Mn-t_{2g} bands changed relative the fermi level, so a polychromatic light may be more effective at capturing the photoexcitation for the full range of the state of charge. The relationship between photoexcitation in Mn d electrons and photo-accelerated fast charging may be applied to other materials systems of interest to the electrochemical energy storage community. For example, LiCoO₂, another commercial cathode system, has t_{2g}-e_{g} transitions possible at ˜300 nm and ˜600 nm, which may be used for photo-accelerated fast charging. Besides cathodes, lithium ion battery anodes are also notable for issues during high-rate charging. Li₄Ti₅O₁₂ is a spinel anode with Ti d states (both t_{2g} and e_{g}) above the fermi level in the visible range that may benefit from photo-accelerated charging.

Fast-charging electrochemistry of LMO was investigated under illumination by red and UV LEDs. It was found that red light provoked an electrochemical response much stronger than that of UV light for acceleration of charging current in LMO half cells. Using the calculated density of states as a guide, in concert with XAS methods, it was demonstrated that the enhanced electrochemical performance may be a result of electronic excitation from the Mn-t_{2g} state into available Mn-e_{g} states. This excitation is possible by absorption of red light; however, the absorption process in UV light may be dominated by excitation of electrons from O-2p into available Mn-t_{2g} states, which is ineffective in promoting enhanced electrochemistry.

### Materials and Methods

LMO thin film synthesis: LMO thin films were synthesized according to the sol-gel method described in Rho, et al. J. Electrochem. Soc. 150, A107 (2003). In brief, isopropanol, polyvinylpyrrolidone (M_{w}=40,000), acetic acid, lithium isopropoxide, manganese (II) acetate tetrahydrate, and water were combined in a mole ratio 40:2:20:1:2:40. All sol-gel materials were purchased from Sigma Aldrich. The sol-gel mixture was spin-coated onto quartz or silicon wafer substrates, which were cleaned by sonication in acetone and isopropanol, and then treated with UV/ozone for 10 minutes. The sol-gel was coated onto the cleaned substrates at 3000 RPM for 15 seconds. The as-prepared sol-gel films were then annealed at 800° C. in air for 1 hour.

LMO powder synthesis: LMO powder was prepared by mixing manganese (II) carbonate (Sigma Aldrich) with lithium hydroxide monohydrate (Sigma Aldrich) in a Mn:Li ratio of 2:1. The powders were mixed in a mortar and pestle for 15 mins before heating at 750° C. in air for 12 h. After cooling, the powder was mixed with mortar and pestle for an additional 15 mins and heated at 750° C. for 12 h again in air to ensure complete conversion. XRD was performed to verify phase purity.

Electrochemical characterization: A cathode electrode slurry was prepared by mixing LMO (80 wt %) with Super P® (10 wt %, MTI Corp, a conductive carbon) and polyvinylidene difluoride binder (10 wt %, APV Engineered Coatings, “PVDF”) in an N-methyl-2-pyrrolidone (NMP, Alfa Aesar). The slurry was doctor blade coated onto either a transparent indium tin oxide/polyethylene terephthalate (ITO/PET) current collector or Al foil, and dried at 70°° C. overnight. A typical electrode loading was about 4.2 mg LMO cm⁻². Electrode disks were punched from the coated substrates and assembled into size 2032 coin cells in an argon-filled glove box having oxygen and moisture levels of less than 1 ppm. Electrochemical cells were composed of a lithium metal counter electrode (MTI), Celgard® 2300 separator, and 1.2 M LiPF₆ dissolved in a mixture of ethylene carbonate and ethyl methyl carbonate 3:7, by weight (Tomiyama). Electrochemical measurements were taken using a Bio-Logic VMP3 multichannel potentiostat. Galvanostatic cycling was conducted at a C/10 rate in the voltage range of 3.5 V-4.4 V. After the windowed cell was assembled, they underwent 3 galvanostatic formation cycles, 3 chronoamperometry (20 min 4.07 V) events, and subsequent chronopotentiometry (C/5 discharge to 3.5 V) cycles to ensure reliability prior to LED illumination. During ‘light on’ experiments, compressed air cooling was activated, and the LED was turned on for 5 minutes prior to beginning voltage hold. During discharge, the LED and cooling were both turned off. Electrochemical impedance spectroscopy (EIS) measurements were taken from a frequency of 0.1 Hz to 100 kHz.

LED illumination setup: For the ‘light on’ experiments UV (385 nm) and red (623 nm) LEDs (Thorlabs SOLIS-385C, and SOLIS-623C, respectively) were mounted on a breadboard. Windowed coin cells were mounted 20 cm from the LED using an adjustable lens mount (Thorlabs), and electrical contact was made via a coin cell holder (Keystone electronics). A thermocouple was mounted to contact the coin cell, and the temperature was monitored using a data logger thermometer (Omega Engineering HH378). For safety, all components were contained within an interlocked optical enclosure to prevent light leakage into the lab. Not only was compressed air directed at the cell for cooling, but additional compressed air for cooling was fed into the enclosure to prevent temperature changes on the windowed coin cell during light exposure. LED power was measured using a Newport 843-R power meter, and incident optical power from each LED was calibrated to be equal at the surface of the cell. Calibration curves resulted in a driving current of 1125 mA for the UV LED and 8000 mA for the red LED for an optical power of 180 mW cm⁻².

Materials characterization: UV/Vis absorption and transmittance measurements were conducted using a Cary 5000 UV-Vis-NIR spectrophotometer. XRD on thin films was conducted using a Bruker AXS D8 DISCOVER GADDS Microdiffractometer with Cu Kα radiation (λ=0.154 nm). XRD on LMO powder was done using a Bruker D8 diffractometer with Cu Kα radiation (λ=0.154 nm).

XAS experimental details: LMO electrodes on Al current collectors were assembled into coin cells as described above. All cells underwent three galvanostatic cycles between 3.5 V and 4.4 V, at which point they underwent galvanostatic charge to a varied SOC based on a fraction of the capacity of the previous cycle correspond to either 33%, 67%, or 100%. Then, in an argon-filled glove box, the cells were disassembled, and the electrodes removed and sealed in a polyethylene pouch. Mn K-edge XAS measurements were conducted on the bending magnet (10BM) beamline of the Materials Research Collaborative Access Team in the Advanced Photon Source at Argonne National Laboratory. Electrode samples were measured in transmission mode using ion chamber detectors for both incident and transmitted beams. A third detector in the series simultaneously collected a metallic Mn reference spectrum with each measurement for energy calibration. The zero-crossing of the crossing of the second derivative was set to 6,537.7 eV. LEDs were mounted 20 cm from the sample, and the same optical power was used as described above. Samples were measured first in dark and then in red or UV illumination. XAFS fitting was performed using Artemis software, in which amplitude reduction factor, Debye-Waller factor, energy change, and interatomic distance were fitted based on well-known spinel LMO crystal data and scattering paths.

### Example 2

In this example, light-emitting diode (LED) photo-assisted fast charging was applied to large bandgap Li₄Ti₅O₁₂ (LTO) cubic spinel to supplement charging speed through material structure-electronic coupling. The ion diffusion and addition of nearly 3 lithium cations during the electrochemical lithiation reaction to the product cubic Li₇Ti₅O₁₂ spinel is increased by 1.3 times through ultraviolet (UV) LED-generated light irradiation on to the electrode interface. This ultimately resulted in a decrease in charging time by approximately 30% under ambient conditions. Red LED light, in contrast, did not provide enough energy to the system to speed up the reaction. Without being bound by any theory, the light energy tuned to the band gap of the material may lower the activation energy barrier to lithium motion within the two-phase reaction front due to the production of localized and less highly charged photo-reduced Ti(3+) metal centers.

Electrochemical (de) intercalation reactions that occur within electrodes in lithium-ion batteries feature lithium-ion motion in the bulk and charge-balancing electron hopping between metal centers and/or band filling/unfilling processes. Charging processes in lithium-ion batteries may be accelerated by perturbation of lithium-ion diffusion or the mechanism of band filling/unfilling.

Since fast charging and discharging processes are limited by the kinetics in the anode and in the cathode, photo-accelerated electrochemical processes were studied in the anode.

### Results and Discussion.

To evaluate the photon effect of light on anodes, a demonstration with lithium titanium oxide (LTO, Li₄ Ti₅O₁₂) spinel anode was performed to probe the photo-accelerated fast charging mechanism. Using 20 minutes-long chronoamperometry experiments, the anode gained 30% more capacity under illumination of UV light compared to both the dark conditions and red light illumination conditions. Different results obtained from light and dark conditions indicated that a lower electronic impedance and faster diffusion of Lit ion may be observed in the lithiation (charging) process in the anode active materials. The electron excitation from the Fermi level to the conduction band may account for the fast charging property of LTO, and the electronic transition may use photon energy matching the band gap for excitation. Therefore, by using both photon-active cathode and anode materials, faster charging speeds of full cells may be achieved under dual illumination of both the cathode and the anode.

Electrode preparation and cell fabrication: The LTO electrodes were prepared by traditional doctor blade method to obtain the uniform coating. In order to enhance the light penetration and increase the interaction area, a porous Ni foam substrate was applied in anode electrode as the current collector. Upon drying in the vacuum oven, 15 mm LTO on Ni foam discs were punched out and assembled in a windowed coin cell. The open window on the coin cell case was purposely designed by creating a hole with a diameter of 8 mm so to expose the LTO electrode surface directly for light interaction. Outside the window, a transparent quartz disc was glued by epoxy to protect the cell from atmosphere. Such self-standing foam electrode may be convenient for future usage in transparent pouch cells. Scanning electron microscope (SEM) and energy-dispersive spectroscopy (EDS) mapping images confirmed the uniform coating of the LTO laminate. Galvanostatic cycling profiles between the voltage from 1 V vs. Li^{+/0} to 2.5 V vs. Li^{+/0} showed reliability and accuracy of the as-prepared LTO windowed coin cell.

Electrochemistry characterization: Fast-charging phenomenon was detected in the electrode material under illumination with a specific paired wavelength of light. The photon energy generated through the light source matches the energy of LTO's band gap to excite electrons from the ground state to a state in the conduction band. Considering the electronic structure in the LTO electrode, LED light with photon energy of about 3 eV was hypothesized to provoke the rapid charging behavior. To investigate this hypothesis, LEDs with selective wavelengths were prepared to provide the optical driving force. The electrochemical performance of the windowed coin cell was characterized at both “light on” and “light off” conditions in a dark optical enclosure. Prior to light experiments, LEDs were adjusted to the same level of incident power (mW/cm²). Compressed air working as the cooling gas was kept on during the “light on” period to insulate any heat effect from LED irradiation. The temperature in the cell and atmosphere were also recorded by thermocouples along with the experiment.

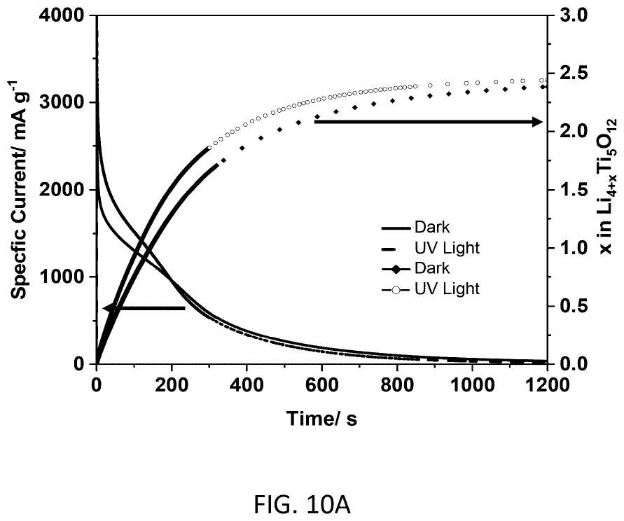

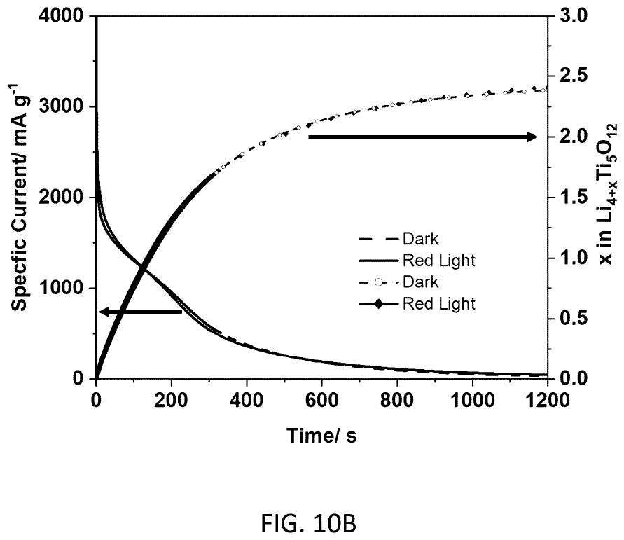

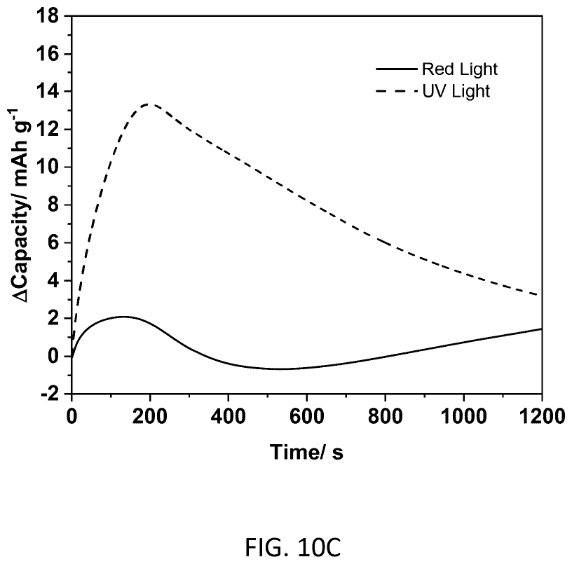

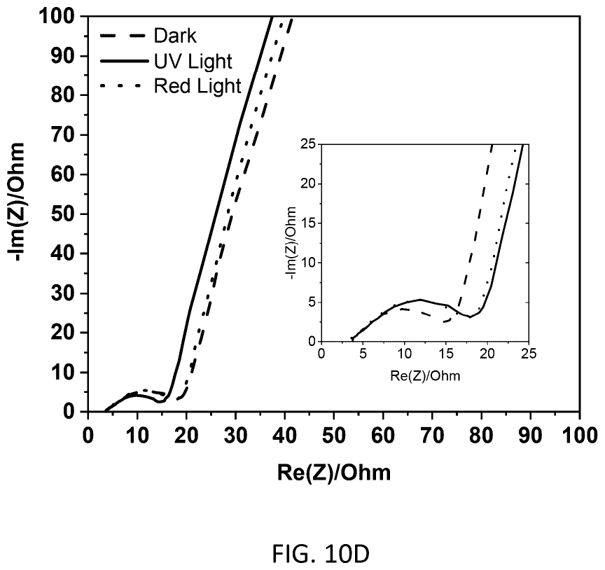

To investigate the influence of light on fast charging behavior, the current flowing in the windowed coin cell was collected while applying constant voltage with or without illumination, followed by galvanostatic charging in dark conditions. Two constant voltages, 1.2 V and 1.4 V were chosen to provide a reasonable current and capacity. A UV LED with a sufficient power (3.2 eV photon energy) was first allowed to shine on the cell. As predicted, a higher current was observed within the first 200 seconds of illumination in the chronoamperometry experiment at 1.2 V. Meanwhile, in a 20 minutes-long chronoamperometry test, UV light illumination contributed to a faster lithiation process compared to the dark state (FIG. 10A). Next, when holding the cell at 1.4 V, the same electrochemical response was demonstrated with a smaller impact from UV illumination, because 1.4 V is closer to the reaction voltage plateau of LTO. A red LED with a photon energy of 2 eV was then used to illuminate the LTO anode in the same cell. Because of the insufficient photon energy, there was no change between the illuminated and the dark conditions (FIG. 10B). Negligible contribution came from the Ni foam substrate. The subsequent galvanostatic charging experiment (with a constant current of 0.1 C rate) after each voltage hold discharge experiment, measured without illumination, validated the consistency of delithiation in LTO. As observed from chronocoulometry results (FIG. 10C), illumination with UV light continually promoted fast discharging and reached the peak speed around 200 seconds into the chronocoulometry experiment, leading to a large increase in capacity on average of 13 mAh g⁻¹ per charge event The uphill trend seen with UV illumination shows that fast charging is favorable in the early stages of charging. In contrast, LTO with red light illumination sometimes demonstrated slower discharging activity compared to the dark condition. As shown in FIG. 10D, electrochemical impedance spectroscopy (EIS) revealed that the LTO electrode illuminated with UV light had a lower energy barrier to enable the migration of Lit ion from the electrolyte to the electrode. Likewise, no obvious difference was detected between red light and dark conditions. It is worth noting that the charge transfer resistance of the windowed coin cell was significantly reduced under illumination with UV light, which altered the electrode reaction kinetics at the interface. Therefore, photo-accelerated fast charging can also increase the rate of the lithiation process in the anode materials when the illumination light has an energy matching the band gap of the anode material.

For practical applications, the voltage efficiency (VE) and energy efficiency (EE) of lithium ion battery may be considered. Energy efficiency represents the utilization of chemical energy stored in lithium-ion cells at discharge or the utilization of electrical energy toward storing chemical energy charge. VE was calculated based on cyclic voltammetry (CV) profiles. An anodic peak shift towards the left was observed from CV curves with illumination, which indicates the voltage efficiency improved with UV illumination, indicating the potential increase of EE. Different current rates were applied in both light and dark states. The LTO windowed coin cell demonstrated stable cycling performance even at a 4C rate. Besides, the current efficiency calculated based on the galvanostatic curves showed the LTO windowed cell with UV illumination had better EE compared to that in the dark state.

In summary, in a demonstration with the LTO spinel anode, the LTO spinel anode had a faster charging speed of about 17% when UV light illuminated the anode, as compared to charging the anode in the dark state. The charging current rate was unchanged from the performance in the dark condition when the light energy (such as red light) was not electronically coupled to the anode material band gap. The band gap of LTO may be better matched to the incident energy of UV light with an initial bandgap of approximately 3 eV. Photo-accelerated electrochemical reactions in batteries may be associated with electron-hole formation in intrinsically wide-band gap insulators or semiconducting materials.

### Example 3

In this example, a photo-accelerated full cell system was developed. The full cell included a LiMn₂O₄ (LMO) spinel cathode and a Li₄Ti₅O₁₂ (LTO) anode. Previously in half-cell experiments, the LMO cathode demonstrated a 13% increase in cell charge capacity when 623 nm red light was shone on the LMO electrode during a 4.07 V constant voltage charge, compared to cells in the dark. Also previously in half-cell experiments, the LTO anode demonstrated increased speed of discharging when illuminated with UV light, resulting in a 17% higher final cell discharge capacity after applying 1.25 V for 20 minutes compared to cells kept in the dark. This example presents the performance of LTO/LMO full cells and discusses the photo-effect in the full cell system.

### Results and Discussion

Cathode electrodes were prepared by mixing LMO (80 wt %, Sigma) with Super P (10 wt %, MTI Corp) and PVDF binder (10 wt %, APV Engineered Coatings) in an N-Methyl-2-pyrrolidone (NMP, Alfa Aesar) slurry. The slurry was doctor blade coated onto Al foil, Al mesh, and ITO/PET and dried at 70° C. overnight. The same method was used to prepare the anode electrode. LTO (70 wt %, MTI Corp) with Super P (20 wt %, MTI Corp) and PVDF binder (10 wt %, APV Engineered Coatings) in an N-Methyl-2-pyrrolidone (NMP, Alfa Aesar) were mixed together to prepare the anode slurry. The anode slurry was doctor blade coated onto Cu foil, Cu mesh, and Ni foam and dried at 70°° C. overnight. Electrode disks were punched and assembled into size 2032 coin cells in an argon glove box with oxygen and moisture levels below 1 ppm. Full cells were composed of a cathode electrode, an anode electrode, Celgard 2300 separator, and 1.2 M LiPF₆ dissolved in a mixture of ethylene carbonate and ethyl methyl carbonate in a ratio of 3:7 by weight (Tomiyama). All cells underwent three formation galvanostatic cycles between 2.2 V and 3.0 V.

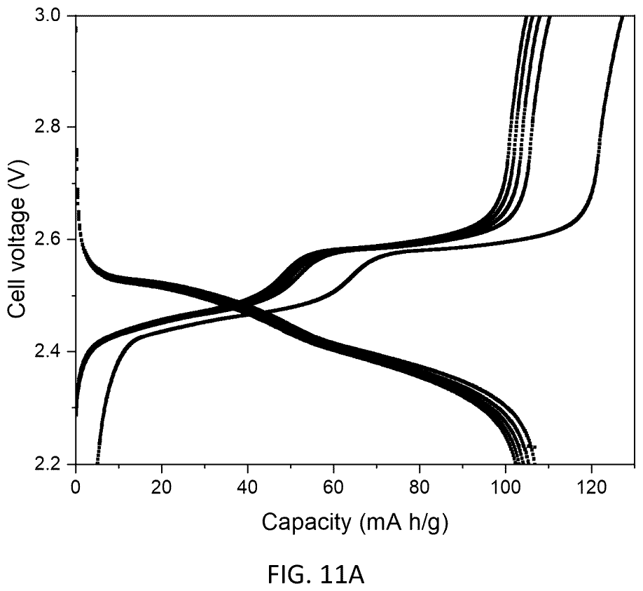

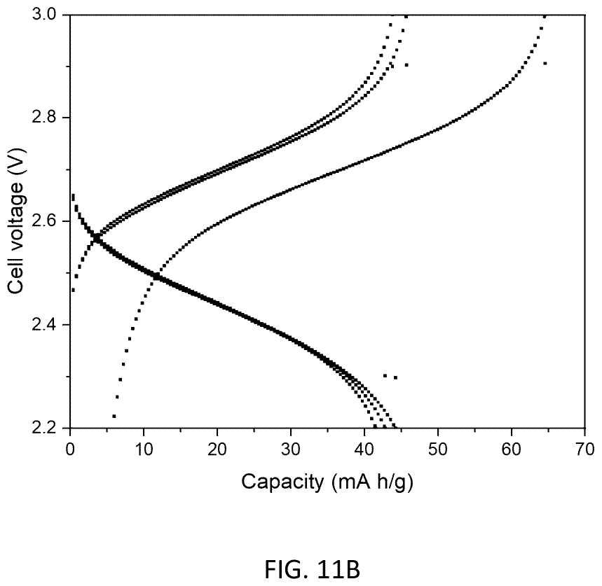

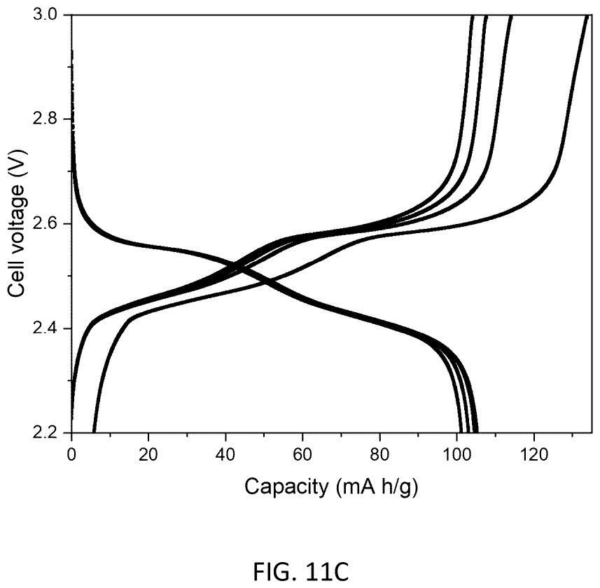

In this study, three different combinations of current collectors were evaluated. To establish a reference for galvanostatic cycles at 0.1C of LMO/LTO full cell, coin cell 1 with conventional Al foil and Cu foil current collectors is used for comparison. Based on the previous study, Ni foam was used for the LTO electrode and ITO/PET was used for the LMO electrode in coin cell 2 (FIG. 11B). Compared with coin cell 1, coin cell 2 has a significantly lower specific capacity and relatively high overpotential (FIGS. 11A and 11B). Table 2 shows that ITO and Ni are less conductive than Cu and Al, leading to increased ohmic resistance and reduced capacity during charging and discharging. To improve the ITO current collector's conductivity, an Al foil donut (also called a ring) was added between the coin cell case and the ITO, reducing the active material loading mass on the substrate to 3.09 mg. Due to the porous structure of the Ni foam, the LTO loading mass on the Ni foam (6.27 mg) was more than twice that of the LMO mass on the ITO. This created a large imbalance between the two electrodes, leading to overpotential during charging and discharging and reducing the capacity. To address this issue, Al mesh and Cu mesh were selected as electrode substrates and current collectors in coin cell 3. These metal mesh substrates provided the ability to balance the loading masses in the electrodes and enhanced the conductivity of the current collectors. In coin cell 3, the LTO loading mass on the Cu mesh was 22.47 mg, while the LMO loading mass on the Al mesh was 21.45 mg. As depicted in FIG. 11C, coin cell 3 achieved a capacity similar to that of coin cell 1.

TABLE 2
Resistivity of Current Collector Materials

| Material | Resistivity × 10⁻⁸(Ω m) |
|---|---|
| Al | 2.82 |
| Cu | 1.72 |
| Ni | 6.99 |
| ITO | 7.2 × 10⁶ |

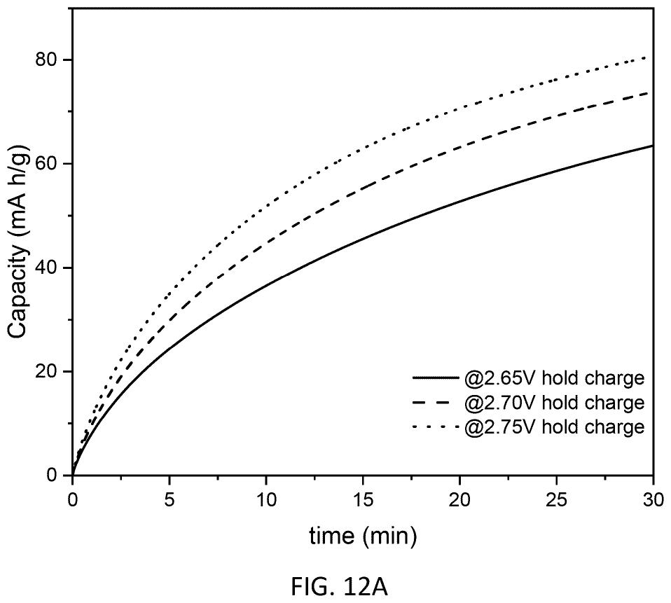

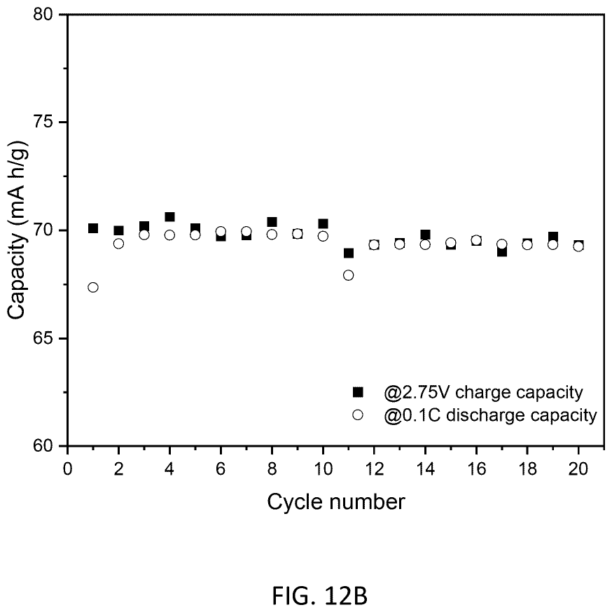

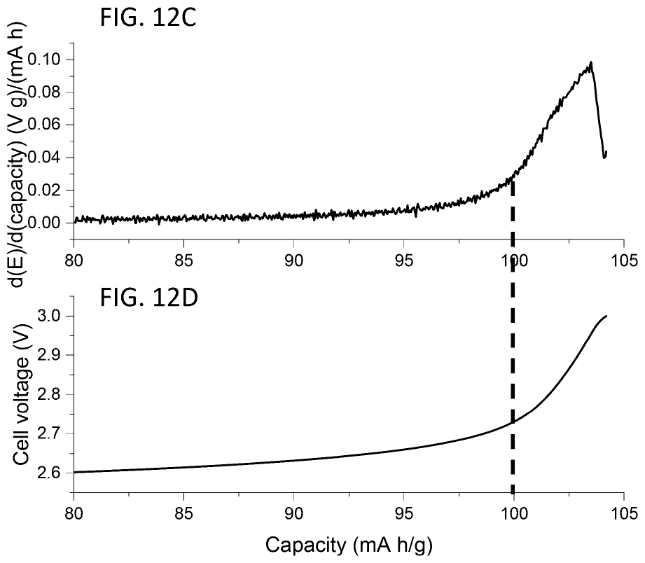

To assess the performance of the cells, three galvanostatic cycles were conducted at 0.1 C for cell formation. Then, a potentiostatic step was employed at a constant voltage for a limited time to charge the cells, followed by a galvanostatic step at 0.1 C to discharge the cells. A voltage was selected that allows for fast charging while minimizing overpotential. To select the voltage, the third galvanostatic cycle (FIG. 12D) was analyzed by calculating the slope of the E-capacity curve (FIG. 12C). The slope remained stable until the capacity reached 100 mA/g, which corresponded to 2.75 V in the previous galvanostatic step. FIG. 12A shows that the charge capacity increased rapidly initially but then slowed down after 15 minutes. However, at 2.75 V, the charge capacity reached approximately 80% of its state-of-charge (SOC) in just 30 minutes. A limited charging time of 20 minutes was used to maintain a high charging speed during long-duration cycling. FIG. 12B illustrates that the cell remained stable for 20 charge/discharge cycles when charged at a constant voltage of 2.75 V and discharged at 0.1 C.

To illuminate the electrode surface, open coin cells with single side windows were assembled, with the window on either the anode or the cathode side. Prior research showed that when the LTO electrode faced the window, 365 nm UV light illumination provoked faster charging, and 623 nm red light illumination generated rapid charging in the cell when the LMO electrode faced the window. To balance the two electrodes and eliminate the effect of lithium plating on the anode, a slightly larger than 1 N/P ratio was chosen. After three galvanostatic cycles, cells were first cycled in the dark, and then in the light. For each cell, EIS was conducted, and then the cells were charged at 2.75 V constant voltage and discharged at 0.1 C constant current.

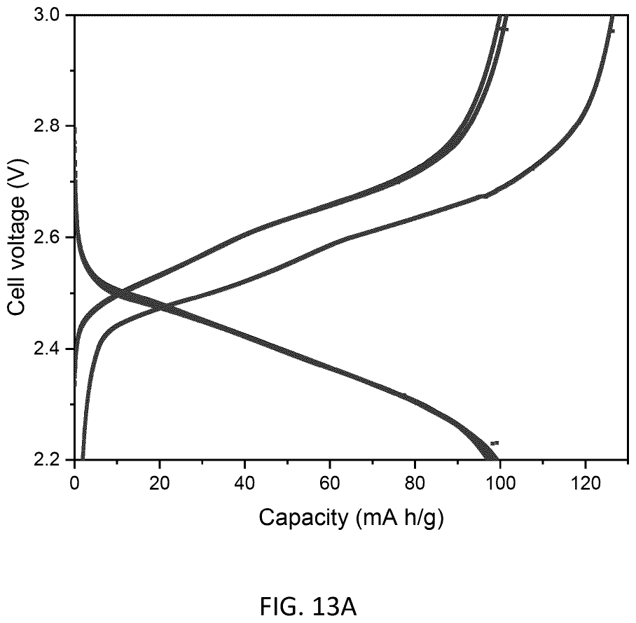

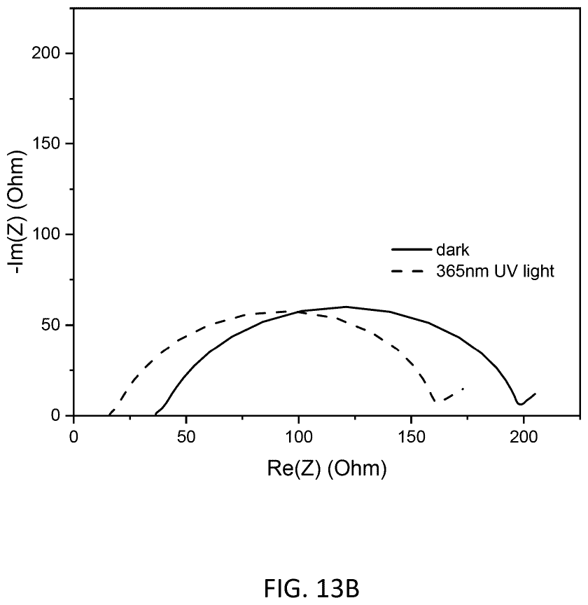

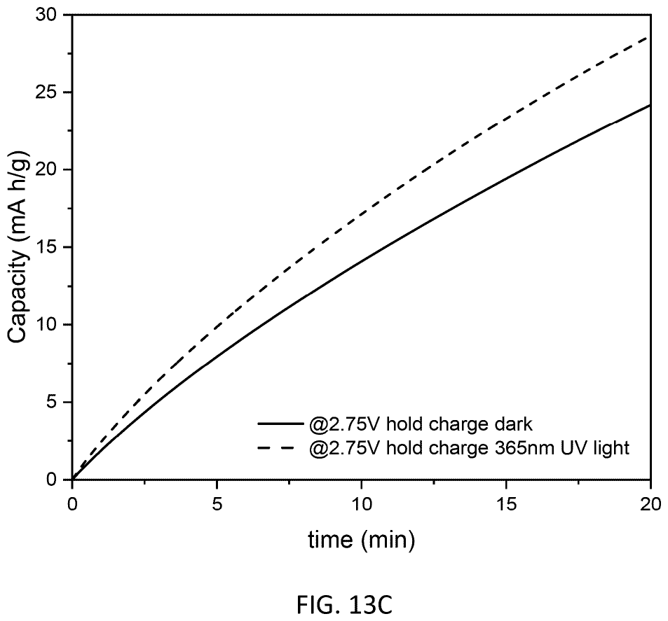

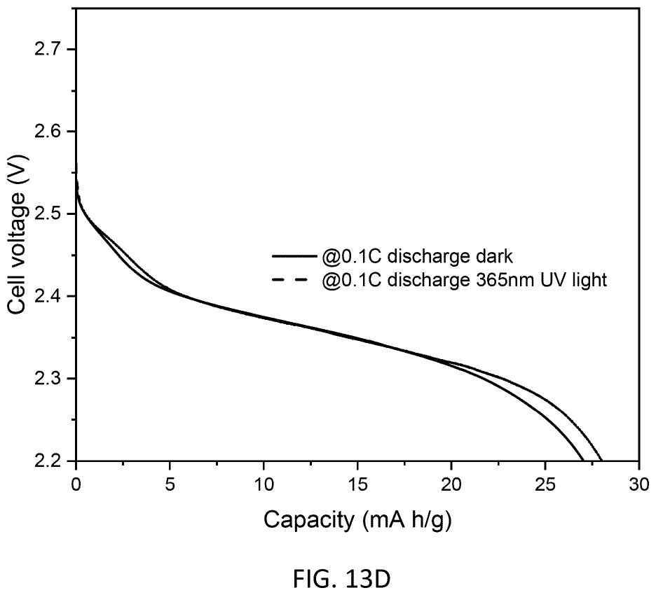

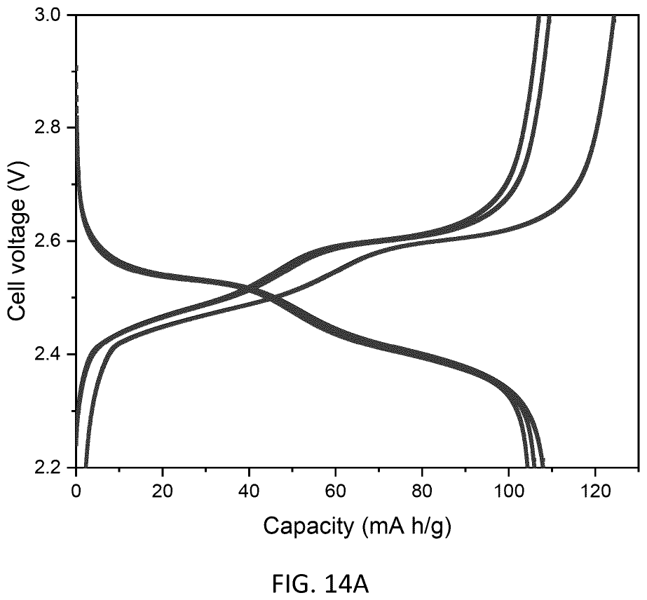

FIGS. 13A to 13D show results from coin cell 4. Coin cell 4 had an N/P ratio of 1.21 and the LTO electrode faced the window. Coin cell 4 showed decreased cell resistance when illuminated with 365 nm UV light, and in 20 minutes of charging at 2.75 V constant voltage, the charging capacity increased by 18% compared to the dark condition.

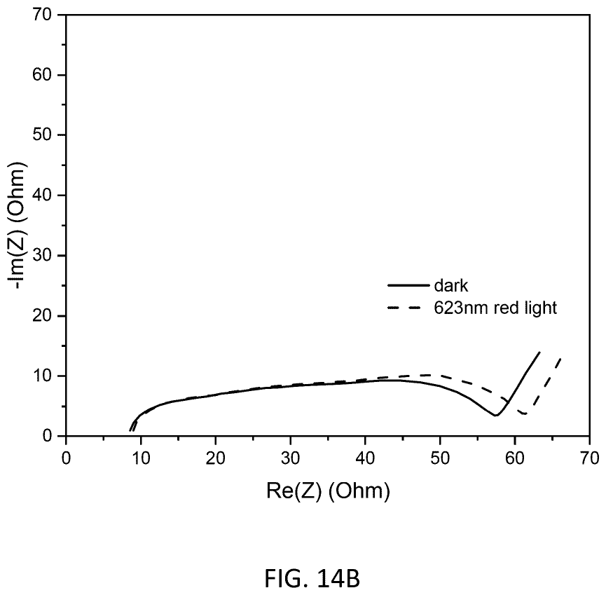

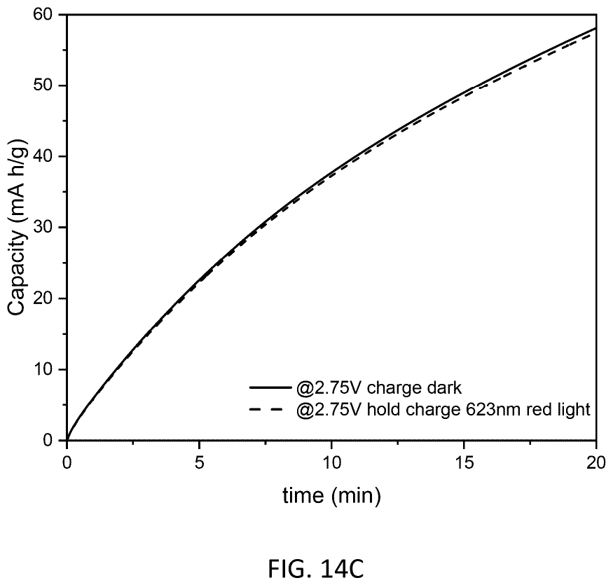

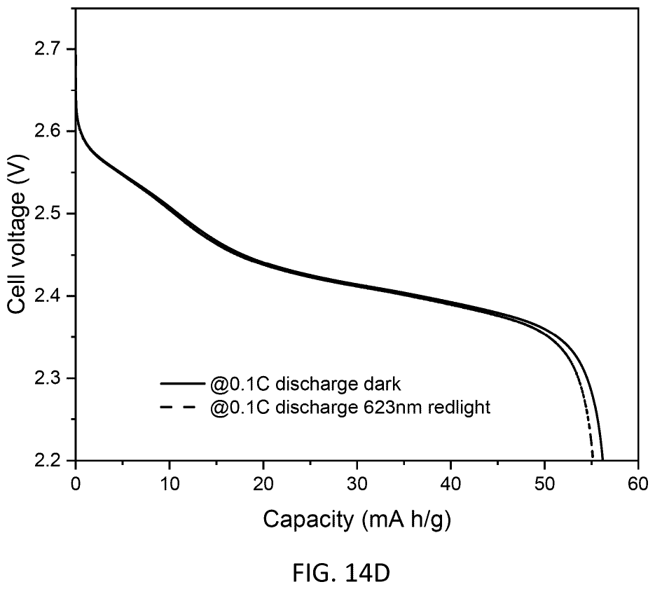

FIGS. 14A to 14D show results from coin cell 5. Coin cell 5 had an N/P ratio of 1.19and the LMO electrode faced the window. In contrast to coin cell 4, illumination with 623 nm red light did not generate fast charging in coin cell 5.

These results indicated that the cells performed differently based on the N/P ratio. To make the electrodes active material loading mass almost the same, the N/P ratio was increased to 1.35 in coin cells 6 and 7. Coin cell 6 had the LTO electrode facing the window. Coin cell 7 had the LMO electrode facing the window.

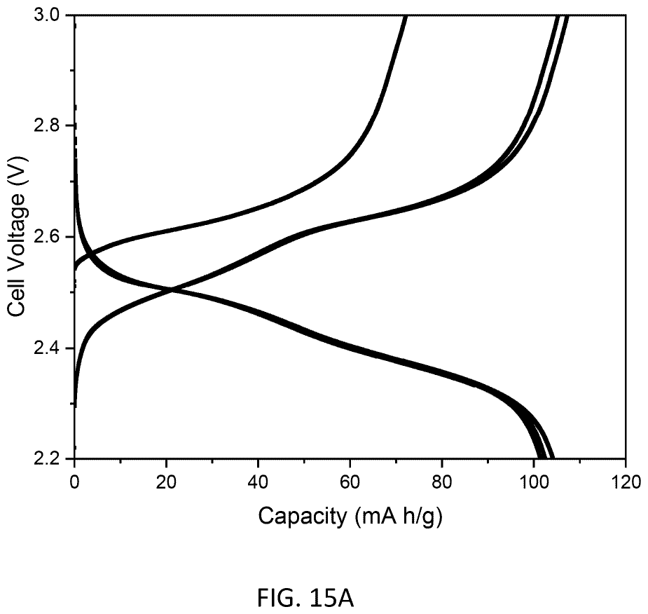

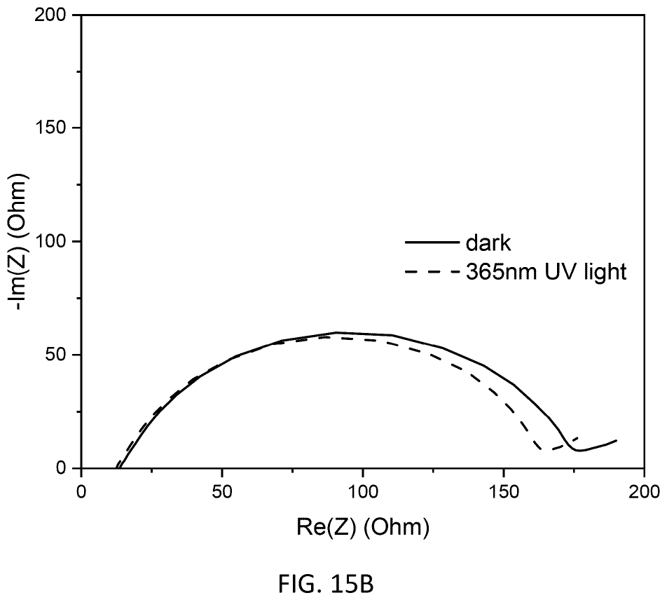

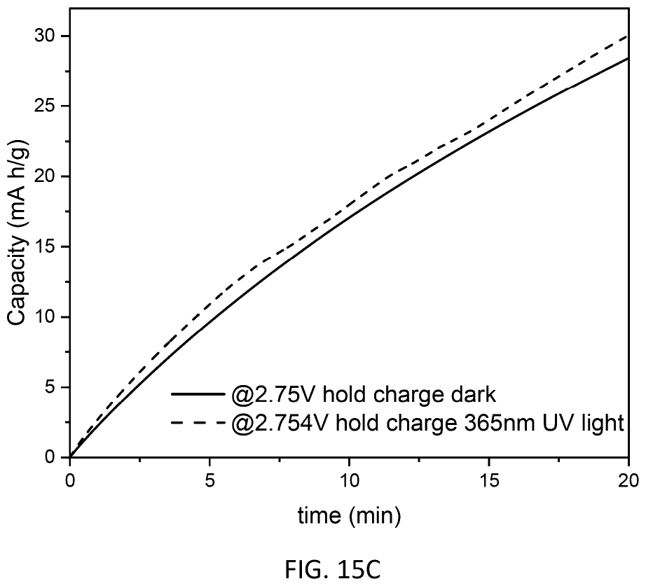

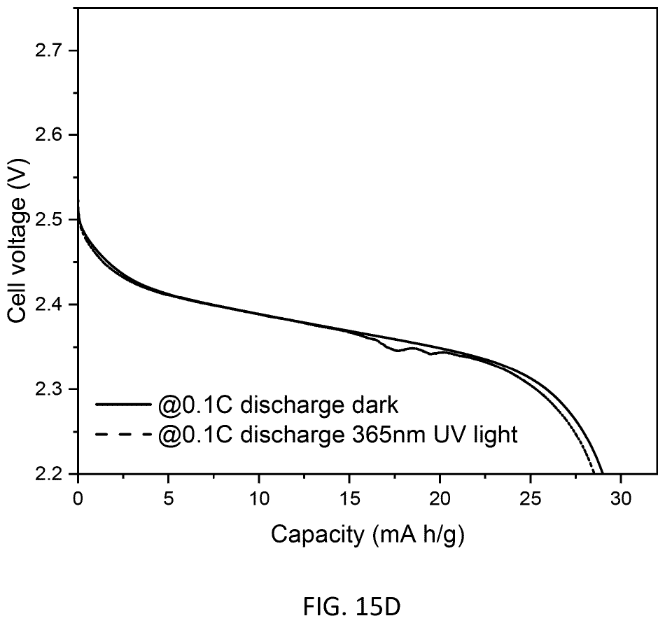

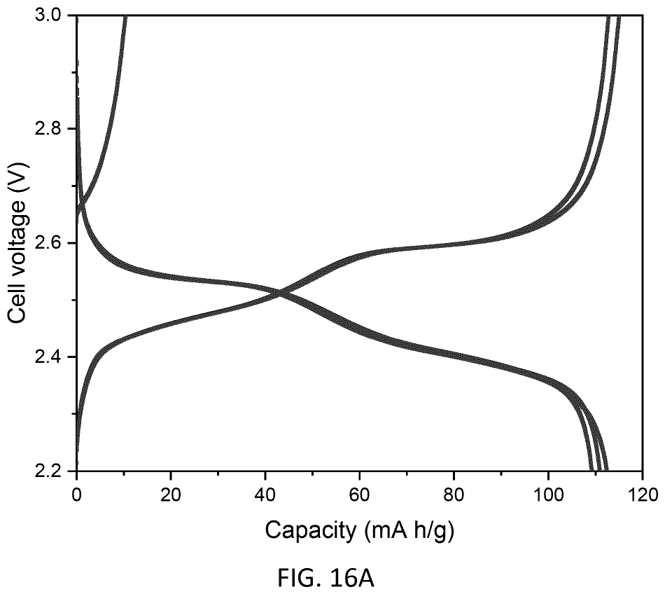

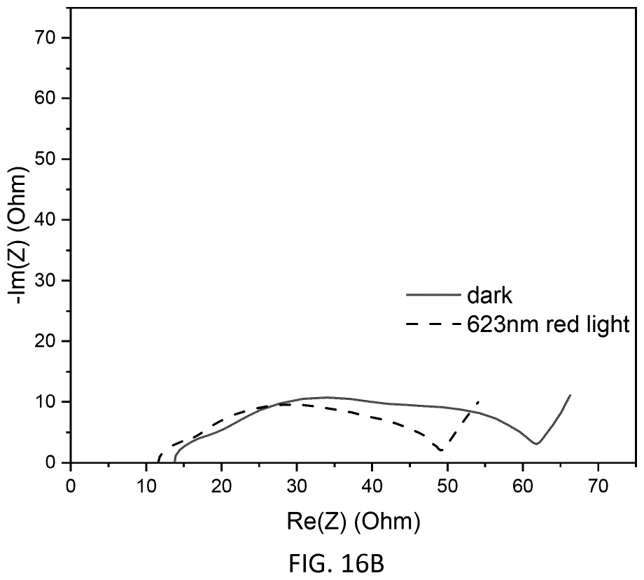

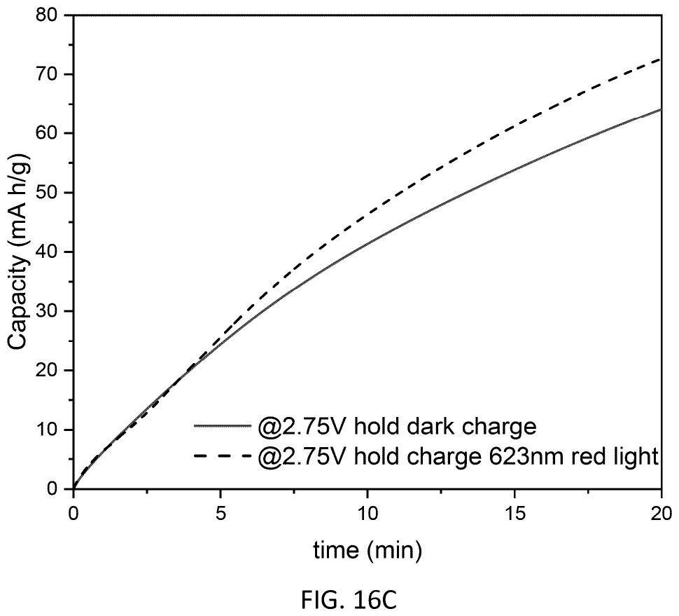

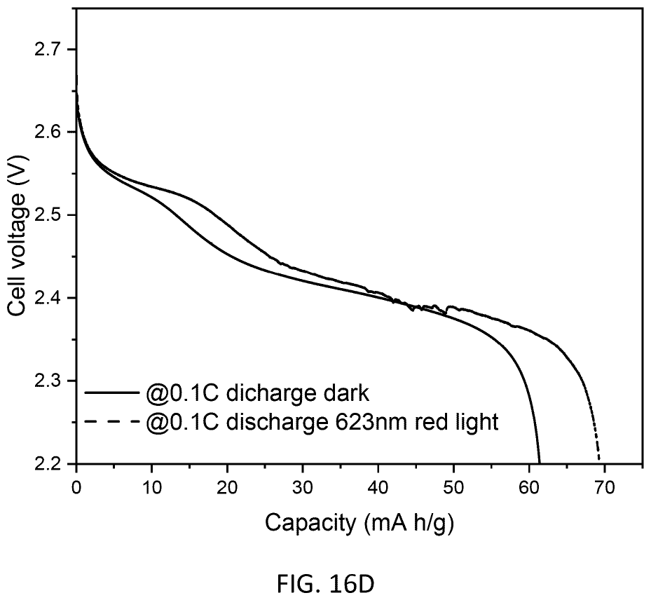

FIGS. 15A to 15D show results from coin cell 6 and FIGS. 16A to 16D show results from coin cell 7. Under 623 nm red light illumination, coin cell 7 showed a lower resistance than the same cell charged in the dark. In a constant voltage charging test at 2.75 V for 20 minutes, the charging capacity increased by 17% compared to the charging capacity in the dark. However, coin cell 6 illuminated with 365 nm UV light did not demonstrate photo-assisted fast charging.

To investigate why red light did not generate fast charging in full cells with an N/P ratio around 1.2, cyclic voltammetry (CV) was used to characterize the lithium diffusivity of the cell. By increasing the scan rate in the CV testing, the cell oxidation peak current and potential became larger due to overpotential. By linear fitting using the Randles-Sevchik equation at the oxidation peak, the lithium-ion diffusion coefficient was calculated, where the lithium-ion diffusion coefficient represents the overall ion diffusion speed in the cell.

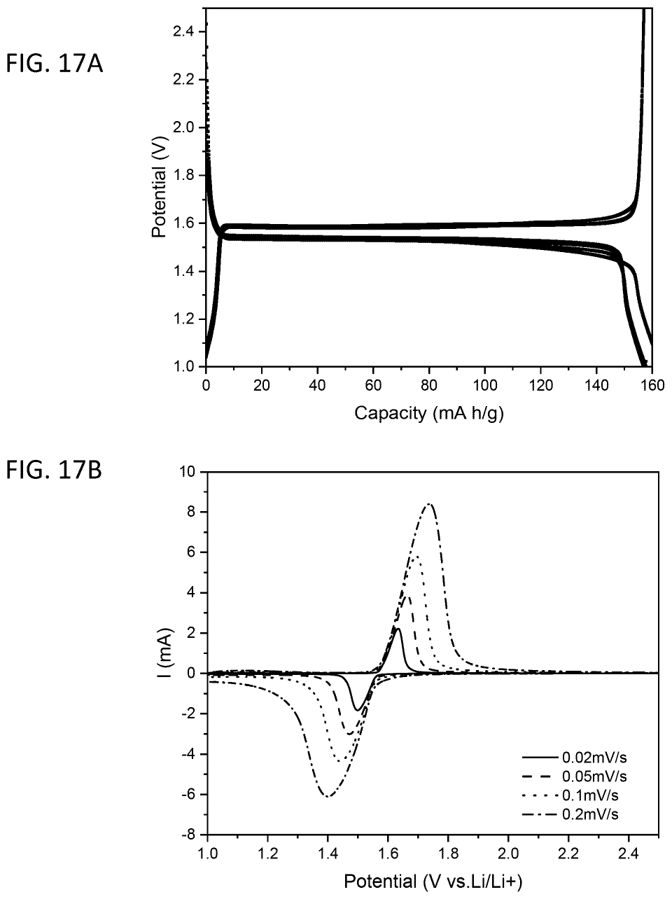

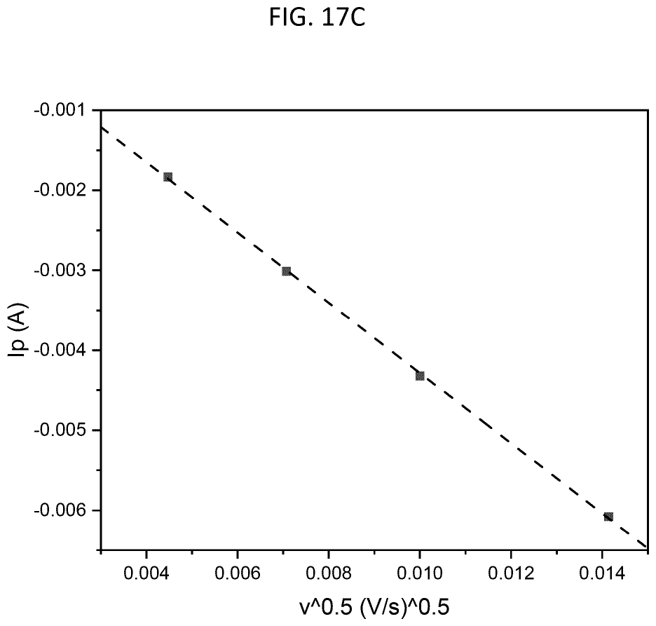

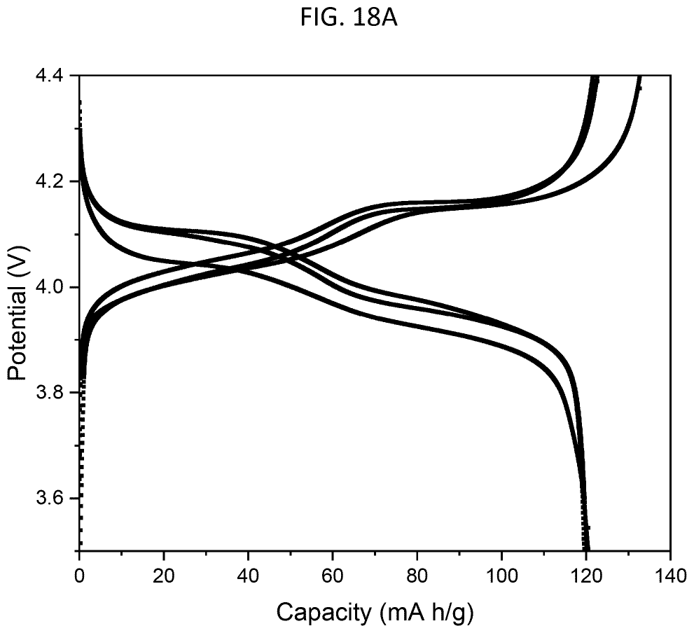

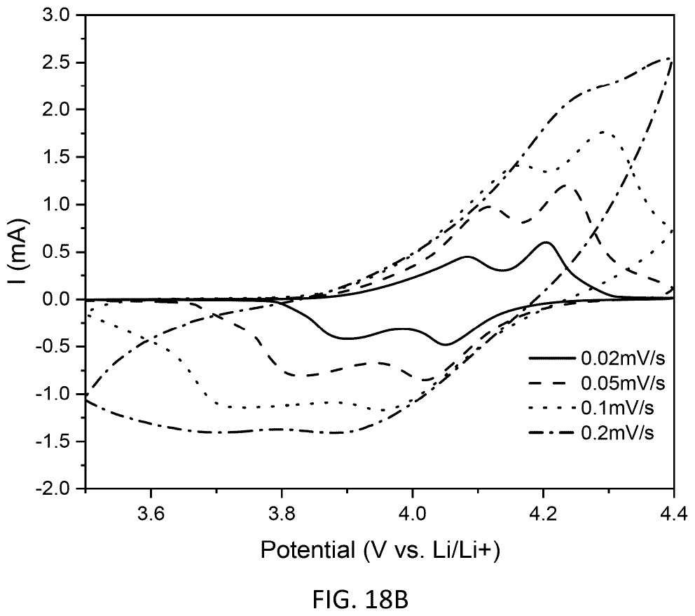

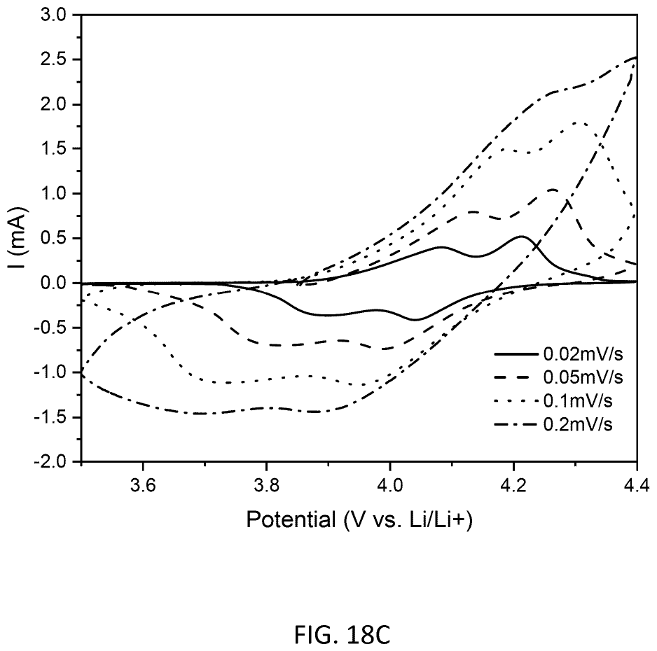

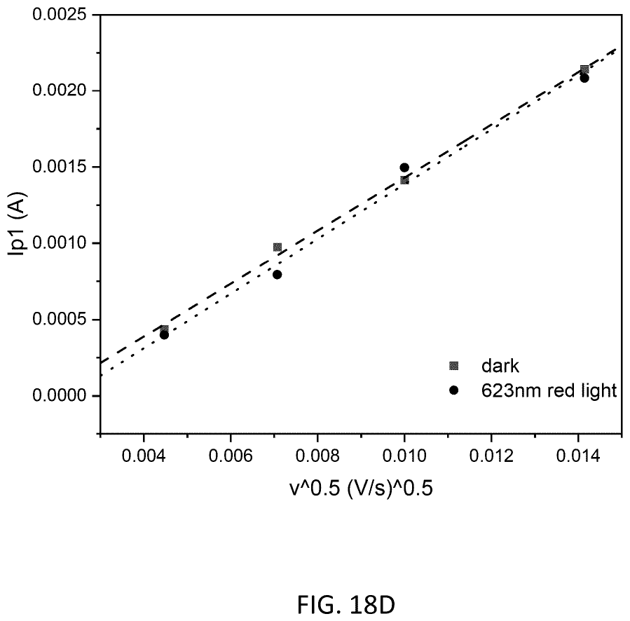

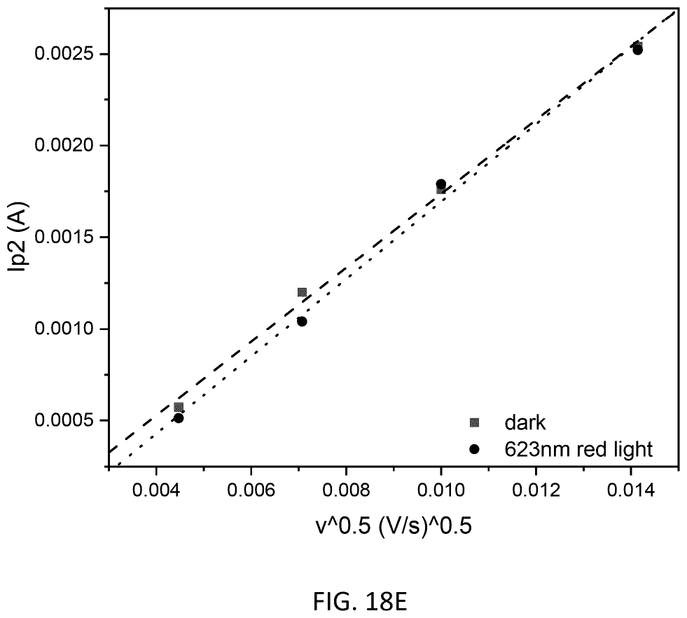

In full cells, the lithium ion diffusivity of two electrodes cannot be characterized separately. To address this issue, a closed coin cell (coin cell 8) without a window was used with an LTO electrode and lithium metal electrode to simulate the LTO electrode in the full cell, and another coin cell (coin cell 9) with a window with an LMO electrode and lithium metal electrode were used to simulate the LMO electrode in the full cell. By changing the active material loading mass, the LTO electrode in coin cell 8 and the LMO electrode in coin cell 9 simulated a full cell with an N/P ratio of 1.2. FIG. 17A and FIG. 18A show that the two cells worked well for the first three galvanostatic cycles, and FIGS. 17B, 18B, and 18C show the CV plots of the cells at 0.02 mV/s, 0.05 mV/s, 0.1 mV/s, and 0.2 mV/s. Diffusion coefficients are presented in Table 3 and Table 4, calculated by linear fitting (FIGS. 17C, 18D, and 18E).

Since LMO has a two-step reaction, two corresponding peaks were shown in the CV curve of coin cell 9, and the diffusion coefficient increased by 7% and 10%, respectively, under illumination with 623 nm light. These results indicate that illumination of the LMO with 623 nm red light provoked faster lithium diffusivity.

In contrast, in closed coin cell 8, the lithium-ion diffusivity coefficient was much smaller than in coin cell 9, indicating that the lithium diffusivity at the LTO electrode in full cells may limit the kinetics. Even if red light provokes faster lithium movement at the LMO electrode, the overall lithium diffusivity in the full cell is limited by the LTO electrode, thereby limiting the full cell charging capacity.

To increase the N/P ratio, the total loading mass, including LTO, carbon, and PVDF on the Cu mesh was also increased, which means that the electron conductivity of the electrode was enhanced by more carbon inside it. Coin cell 6 has a smaller charge transfer impedance compared to coin cell 4 with a smaller N/P ratio. (FIG. 13B, FIG. 15B) Because the two cathodes in these two cells are similar to each other, the decrease in charge transfer resistance results from the LTO side. This suggests that the electrochemical reaction rate was enhanced on the LTO side, and the limitation of the full reaction change to the LMO cathode at higher N/P ratio.

All the results calculated here are larger than the numbers in the literatures because the electrode's surface was regarded as a rigid smooth plate. However, for mesh substrates, the surface area is much larger than that of a plate with the same geometric area, resulting in a larger diffusion coefficient in calculations.

TABLE 3
Coin Cell 9 Lithium Ion Diffusivity

| Window coin cell 9 Diffusion | Lower SOC | Higher SOC |
|---|---|---|
| coefficient (cm²/s) | Peak 1 | Peak 2 |
| Dark | 1.88 × 10⁻⁹ | 2.53 × 10⁻⁹ |
| Illumination with 623 nm red | 2.01 × 10⁻⁹ | 2.79 × 10⁻⁹ |
| light | | |
| Improvement | 7% | 10% |

TABLE 4
Coin Cell 8 Lithium Ion Diffusivity

| Coin cell 8 Diffusion coefficient | |
|---|---|
| (cm²/s) | Calculated data |
| Dark | 6.68 × 10⁻¹¹ |

In conclusion, the effect of light illumination on the charging performance of the LTO/LMO full cell was investigated. It was found that 365 nm UV light could significantly increase the charging capacity of the LTO electrode when it faced the window in a coin cell, while the 623 nm red light had little effect on the charging performance of the LMO electrode. However, when the N/P ratio was increased to 1.35 to balance the loading mass of the two electrodes, the 623 nm red light improved the charging performance of the LMO electrode, but UV light did not generate fast charging. The reason why red light had little effect on the charging performance of the full cell with N/P ratio around 1.1 was further investigated by characterizing the lithium diffusivity of the two electrodes using cyclic voltammetry. Cyclic voltammetry indicated that the lithium-ion diffusion coefficient at the LTO electrode was much smaller than that at the LMO electrode, indicating that the overall lithium diffusivity was limited by the kinetic step at the LTO electrode. These findings provide insights for the design and optimization of lithium-ion batteries with improved charging performance under light illumination.

### Example 4

Cathode electrodes were prepared by mixing Li-rich material (80 wt %, 0.15 Li [Li_{1/3}Mn_{2/3}]O₂·0.9 LiMn_{0.3}Ni_{0.7}O₂ (Argonne) with carbon nanofibers (1 wt %, Sigma-Aldrich), C45 carbon black (9 wt %, MSE Supplies) and Poly (tetrafluoroethylene) solution (10 wt %, Polysciences Inc.) as slurry in ethanol. The slurry was flattened to thin sheet, where electrode disks were punched. The electrode disks were vacuum-dried at 70° C. overnight prior to use. The anode materials were Li foils (MTI Inc.)

### Assembly of the Battery, Formation Cycles and Heat Effect

The batteries were assembled using a homemade windowed battery cell in an Ar-filled glove box where oxygen and moisture levels are both below 1 ppm. The homemade cell has an aluminum block as the cathode current collector and a copper block as the anode current collector. The aluminum block has an open window that was sealed with a piece of quartz for allowing light to come in, the cathode electrodes were put directly on the quartz window. The separator is Celgard 2300, and the electrolyte is 1.0 M LiPF₆ dissolved in a mixture of ethylene carbonate, dimethyl carbonate, and diethyl carbonate in a ratio of 1:1:1 by volume (Sigma-Aldrich). All cells underwent two formation galvanostatic cycles (0.33C rate) between 3.0 V and 4.3 V without any light irradiation prior to further experimentation.

In the following experiments, as light was turned on to irradiate the battery during charging process, a thermal couple was inserted into the aluminum block, which detects the temperature variation was smaller than 0.3 Celsius degree. Thus, heat effect to the battery performance can be ignored.

### Step Charging With Constant Voltage

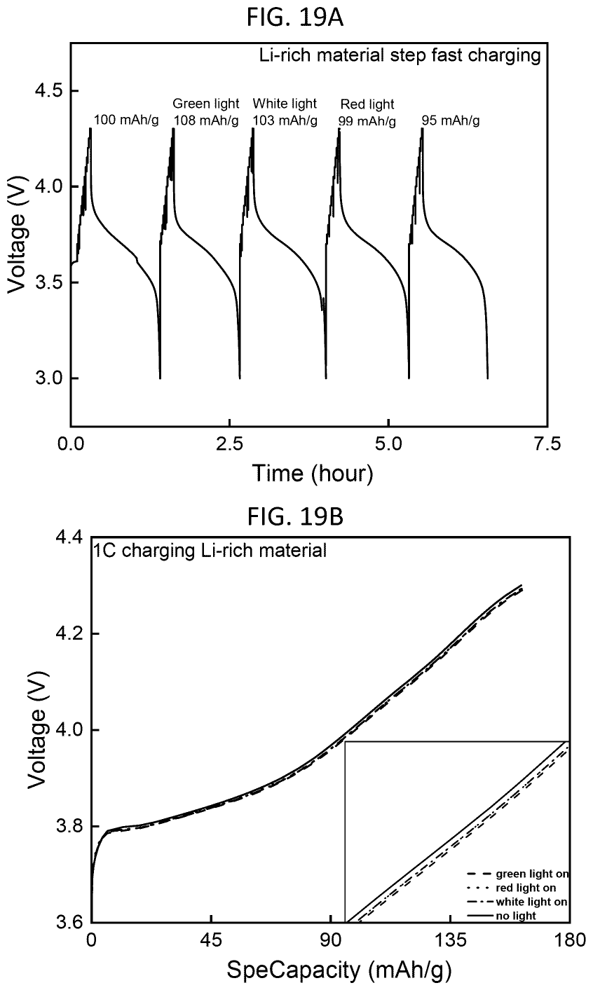

Then, the battery cycling was applied with a constant-voltage step-charging protocol as shown in FIG. 19A. The constant voltage charging starts at 3.70 V, then the constant voltage was increased by 0.05 V until 4.30 V. Each constant voltage charging lasted for 30 seconds(s). Then the battery was discharged under 0.5C galvanostatic cycle to 3.0 V. During the charging process, 525 nm green light, white light, and 623 nm red light were turned on to irradiate the cathode material, respectively, however, they were turned off during the discharging process. Heat filter was added inside the light source to eliminate heat effect from the light.

### 1C Galvanostatic Cycle

The battery cycling was also applied with a galvanostatic charging under 1C rate until the voltage reached 4.30 V. Then the battery was discharged under 1C galvanostatic cycle to 3.0 V as shown in FIG. 19B. During the charging process, green light, red light, and white light were turned on to irradiate the cathode material, respectively, however, they were turned off during the discharging process. It can be seen that the overpotential of the battery at 50% state-of-charge decreases 0.24% (green light on), 0.17% (red light on) and 0.17% (white light on) respectively.

In this example, light-emitting diode (LED) photo-assisted fast charging was applied to Li-rich cathode half-cell to supplement charging speed through material structure-electronic coupling. FIG. 19A shows charging and discharging of the Li-rich cathode under different illumination conditions. The first cycle was conducted under no illumination, the second cycle was conducted under illumination with green light having a wavelength of about 525 nm, the third cycle was conducted under white light, the fourth cycle was conducted under red light illumination, and the fifth cycle was conducted under no illumination. The results showed a faster charging to a higher capacity under illumination with green light as compared to the other conditions.

FIG. 19B shows voltage profiles of charging a Li-rich cathode under different illumination conditions. Consistent with the results in FIG. 19A, charging at 1C under green light illumination reduced the overpotential for charging.

### Example 5

Cathode electrodes were prepared by mixing LiNi0.5Mn1.5O4 spinel LNMO material (80 wt %, MSE Supplies) with carbon nanofibers (1 wt %, Sigma-Aldrich), C45 carbon black (9 wt %, MSE Supplies) and Poly (tetrafluoroethylene) solution (10 wt %, Polysciences Inc.) as slurry in ethanol. The slurry was flattened to thin sheet, where electrode disks were punched. The electrode disks were vacuum-dried at 70° C. overnight prior to use. The anode materials were Li foils (MTI Inc.)

### Assembly of the Battery, Formation Cycles and Heat Effect

The batteries were assembled using a homemade windowed battery cell in an Ar-filled glove box where oxygen and moisture levels are both below 1 ppm. The homemade cell has an aluminum block as the cathode current collector and a copper block as the anode current collector. The aluminum block has an open window that was sealed with a piece of quartz for allowing light to come in, the cathode electrodes were put directly on the quartz window. The separator is Celgard 2300, and the electrolyte is 1.0 M LiPF₆ dissolved in a mixture of ethylene carbonate, dimethyl carbonate, and diethyl carbonate in a ratio of 1:1:1 by volume (Sigma-Aldrich). All cells underwent two formation galvanostatic cycles (1C rate) between 3.5 V and 5.0 V without any light irradiation prior to further experimentation.

In the following experiments, as light was turned on to irradiate the battery during charging process, a thermal couple was inserted into the aluminum block, which detects the temperature variation was smaller than 0.3 Celsius degree. Thus, heat effect to the battery performance can be ignored.

### Step Charging With Constant Voltage

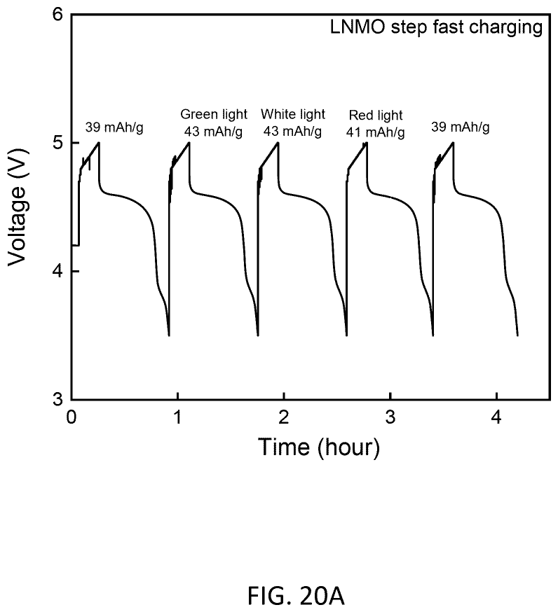

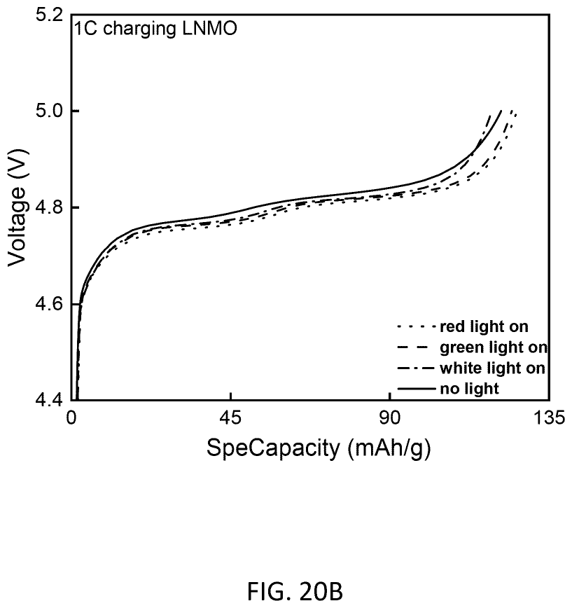

Then, the battery cycling was applied with a constant-voltage step-charging protocol as shown in FIG. 20A. The constant voltage charging starts at 4.70 V, then the constant voltage was increased by 0.01 V until 5.00 V. Each constant voltage charging lasted for 30 s. Then the battery was discharged under 0.25° C. galvanostatic cycle to 3.5 V. During the charging process, 525 nm green light, white light, and 623 nm red light were turned on to irradiate the cathode material, respectively, however, they were turned off during the discharging process. Heat filter was added inside the light source to eliminate heat effect from the light.

### 1C galvanostatic Cycle

The battery cycling was also applied with a galvanostatic charging under 1C rate until the voltage reached 5.0 V (FIG. 20B), then the battery was discharged under 1C galvanostatic cycle to 3.5 V. During the charging process, red light, green light, and white light were turned on to irradiate the cathode material, respectively. However, they were turned off during the discharging process. It can be seen that the overpotential of the battery at 50% state-of-charge decreases 0.33% (red light on), 0.21% (green light on) and 0.16% (white light on) respectively.

### Example 6

In this example, light-emitting diode (LED) photo-assisted fast discharging was applied to a graphite anode half-cell to supplement discharging speed through material structure-electronic coupling.

Graphite electrodes were prepared by mixing Graphite (90 wt %, TIMREX SFG6) with PVDF binder (10 wt %, APV Engineered Coatings) in an N-Methyl-2-pyrrolidone (NMP, Alfa Aesar) slurry. The slurry was doctor blade coated onto Ni foam and dried at 70° C. overnight. Electrode disks were punched and assembled into size 2032 coin cells in an argon glove box with oxygen and moisture levels below 1 ppm. Coin cells were composed of a graphite electrode, a lithium metal disk, Celgard 2300 separator, and 1.2 M LiPF₆ dissolved in a mixture of ethylene carbonate and ethyl methyl carbonate in a ratio of 3:7 by weight (Tomiyama). All cells underwent three formation galvanostatic cycles between 0.01 V and 1.5 V.

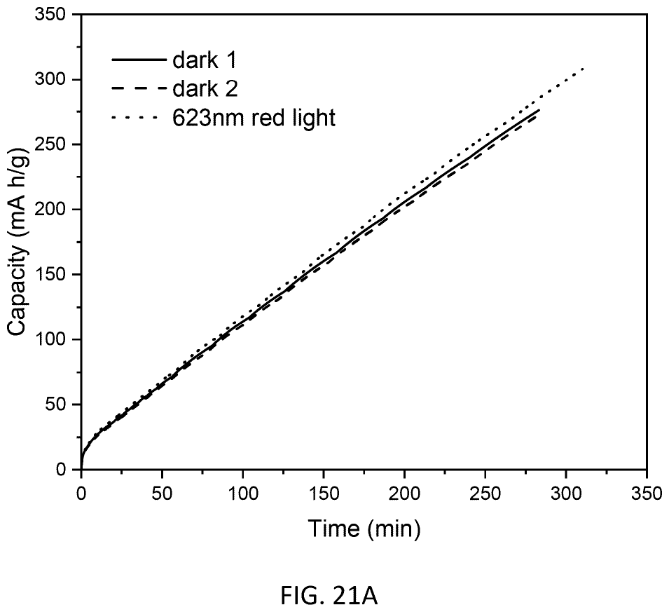

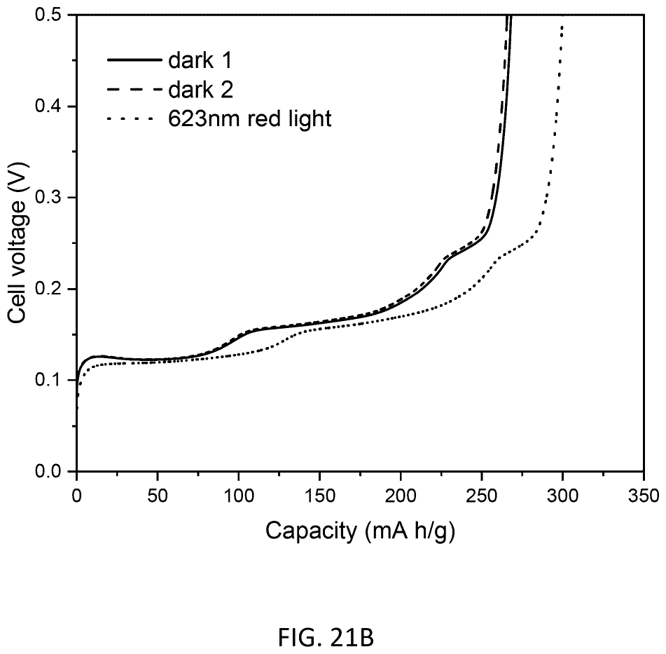

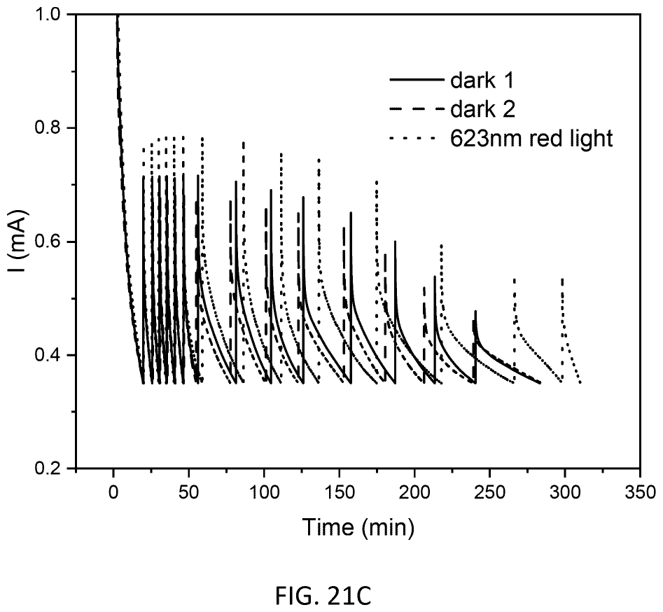

FIG. 21A shows constant voltage discharging from 0.16 V to 0.02 V of a graphite anode illuminated with red light having a wavelength of 623 nm. The cell gained a higher capacity under illumination and discharged faster than the cell not illuminated. FIG. 21B shows voltage profiles of a graphite anode illuminated with red light having a wavelength of 623 nm. FIG. 21C shows charging and discharging of a graphite anode illuminated with red light having a wavelength of 623 nm. Under illumination, the cell reached a higher peak current with the same discharge voltage.

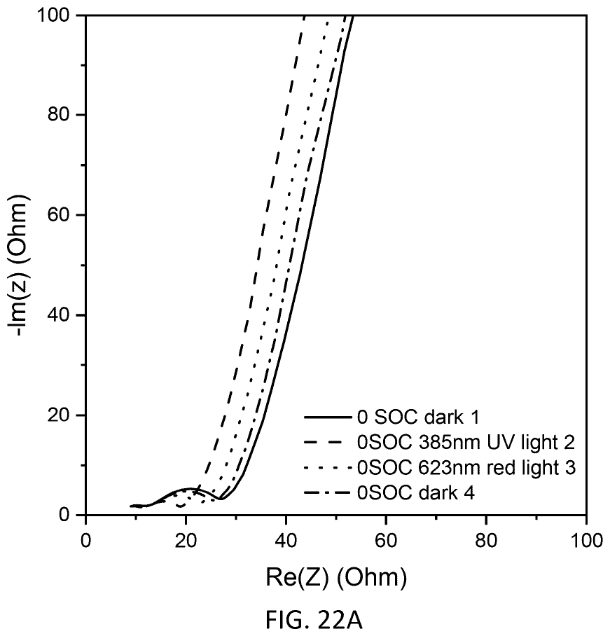

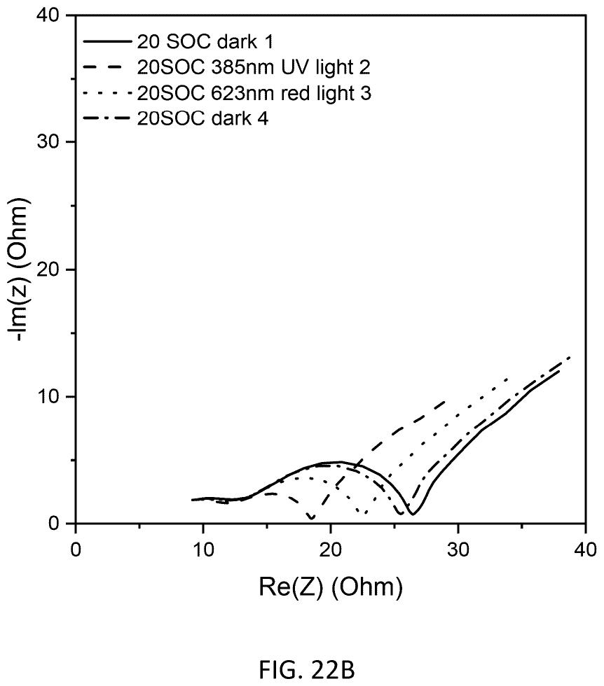

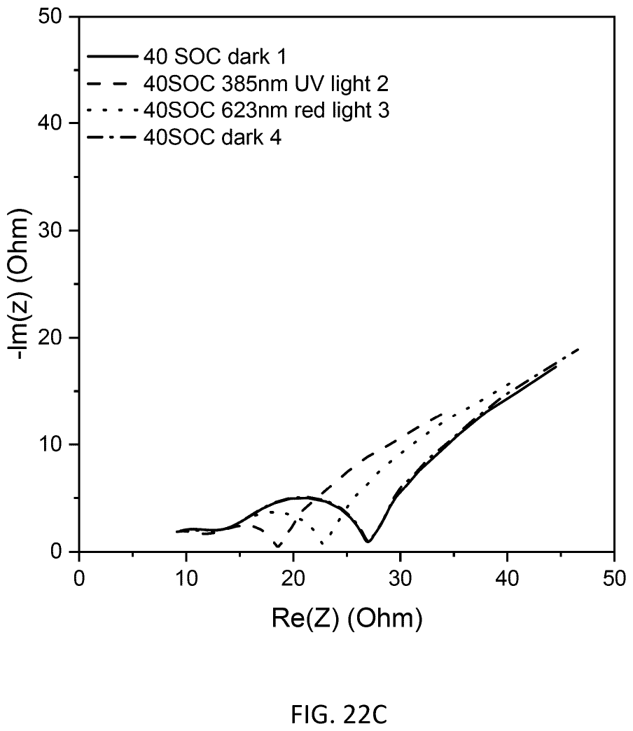

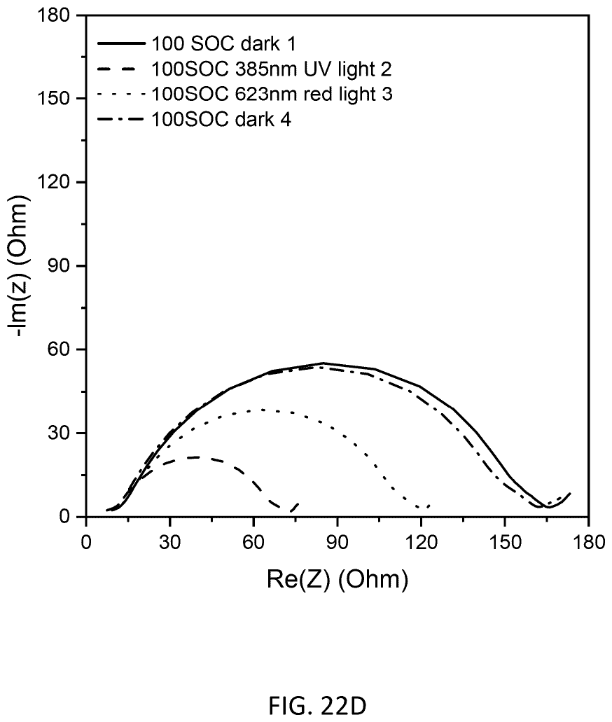

FIGS. 22A to 22D are AC impedance measurements from 100 kHz to 10 MHz with 10 mV amplitude displayed as Nyquist plots of graphite anodes under different illumination conditions and different states of charge. Nyquist plots were collected under dark conditions, under illumination with UV light having a wavelength of 385 nm, and under illumination with red light having a wavelength of 623 nm. FIG. 22A shows graphite anodes at 0% state-of-charge (SOC). SOC was derived from x in LiₓC₆, where LiC₆ was a 100% SOC. FIG. 22B shows graphite anodes at 20% SOC. FIG. 22C shows graphite anodes at 60% SOC. FIG. 22D shows graphite anodes at 100% SOC. Impedance decreases under UV light illumination as SOC increases. Without being bound by any theory, this result may indicate that the graphite conductivity is higher at higher SOC with UV light illumination. Under UV illumination, graphite may be discharged at a fast rate without detectable deleterious side effects.

### Example 7

Graphite electrodes were prepared by mixing graphite (85 wt %, TIMREX) with Vulcan XC72 carbon black (5 wt %, MTI Corp) and a PVDF binder (10 wt %, APV Engineered Coatings) in an N-Methyl-2-pyrrolidone (NMP, Alfa Aesar) slurry. The slurry was doctor blade coated onto Ni foam and dried at 70°° C. overnight. Electrode disks (15 mm diameter) were punched and assembled into size 2032 coin cells in a glove box filled with argon gas, with oxygen and moisture levels below 1 ppm.

Windowed coin cells, featuring an 8 mm hole in the bottom (anode-side) case, were constructed using a graphite electrode, a Celgard 2300 20 μm separator, a lithium metal disc, and an electrolyte solution of 1.2 M LiPF₆ dissolved in a mixture of ethylene carbonate and ethyl methyl carbonate (3:7 by weight, Tomiyama). A transparent quartz disc was affixed to the windowed side case with epoxy (Thorr seal).

For electrochemical testing, cells were aged for 6 hours post-assembly, then all cells underwent 5 galvanostatic charge/discharge cycles at a current rate of 0.1 C as formation cycles. Electrochemical impedance spectroscopy (EIS) measurements were conducted at 0%, 25%, 50%, 75%, and 100% states of lithiation, with a frequency range of 10 mHz to 200 kHz and an amplitude of 10 mV. At each state of lithiation, EIS was measured first in the dark, then under 365 nm ultraviolet (UV) light, followed by 623 nm red LED light, and finally in the dark again. 1250 mA and 8000 mA were used as driving currents for UV and red LED respectively.

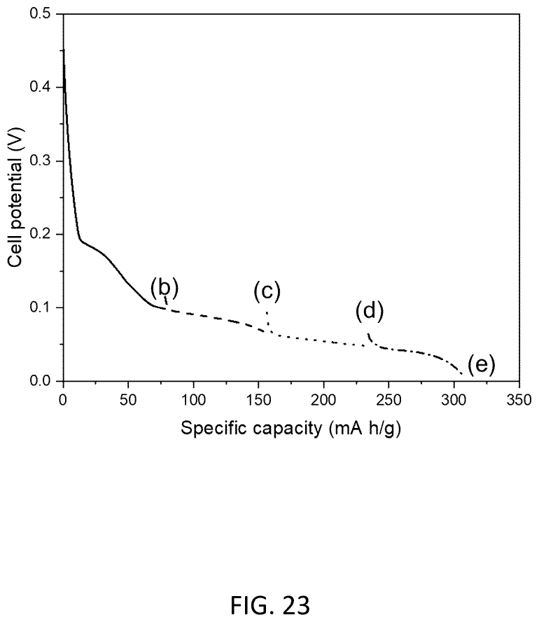

FIG. 23 is a graph of the voltage profile of a graphite anode. Cell discharge capacity and potential are noted at (a) 0% lithiated state; (b) 25% lithiated state; (c) 50% lithiated state; (d) 75% lithiated state; and (c) 100% lithiated state.

Lithiated stages in graphite, defined by the specific arrangements and concentrations of lithium ions between graphite layers, play a crucial role in the performance of lithium-ion batteries. The intercalation of lithium ions into graphite proceeds through a series of well-defined stages, primarily Stage I (LiC₆) and Stage II (LiC₁₂). In Stage I, lithium ions occupy every second layer between graphite planes, leading to a composition of LiC₆. As the lithiation continues and lithium concentration increases, the system transitions to Stage II, where lithium ions occupy every layer, resulting in LiC₁₂. These stages are characterized by distinct changes in potential and capacity. For instance, Stage II typically exhibits a potential plateau around 0.1-0.2 V vs. Li/Li+, while Stage I has a lower potential. The specific capacity of fully lithiated graphite (LiC₁₂) is about 372 mAh/g.

The formation of LiC₁₂ is characterized by relatively rapid lithium diffusion due to lower activation barriers. As lithiation progresses, the transition from stage II to stage I (LiC₆) occurs. This transition is kinetically hindered because it requires a more substantial rearrangement of lithium ions within the graphite structure, leading to higher activation barriers and slower diffusion rates. The formation of stage I involves a sequence of intermediate phases, such as the 3R phase, which further complicates the kinetic profile. During high-rate operations, the lithiation process may become non-uniform, with preferential activation near the separator and significant spatial variation in lithiation states.

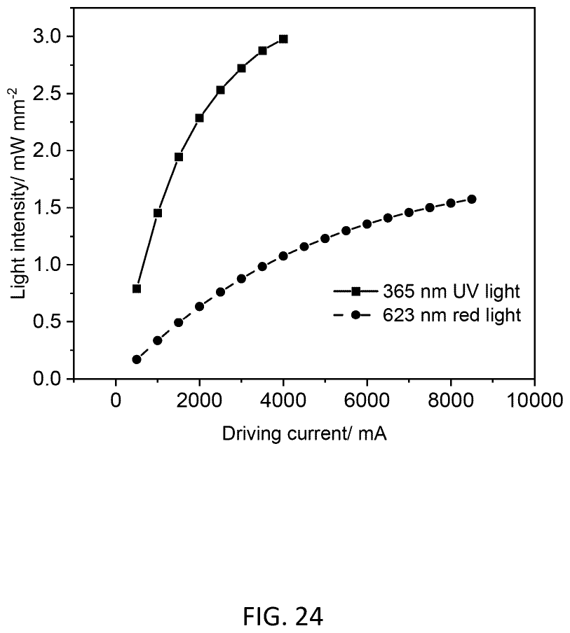

FIG. 24 is a graph of light intensity versus driving current for graphite anodes illuminated with UV light or red light. The UV light used a 1250 mA driving current and the red light used an 8000 mA driving current, where both UV and red LEDs had the same light intensity.

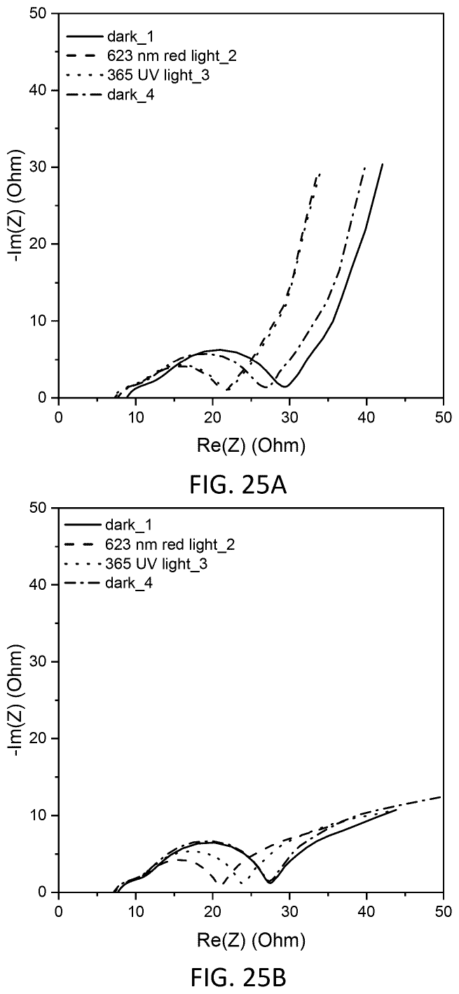

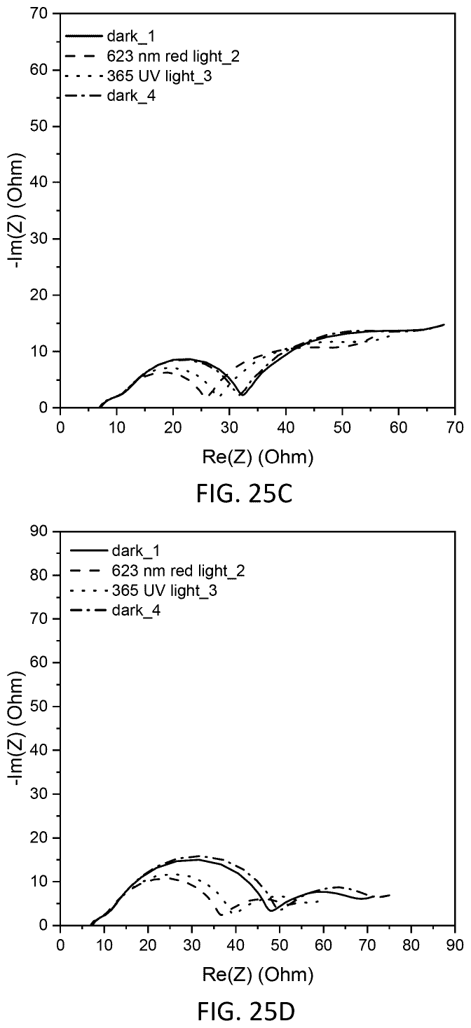

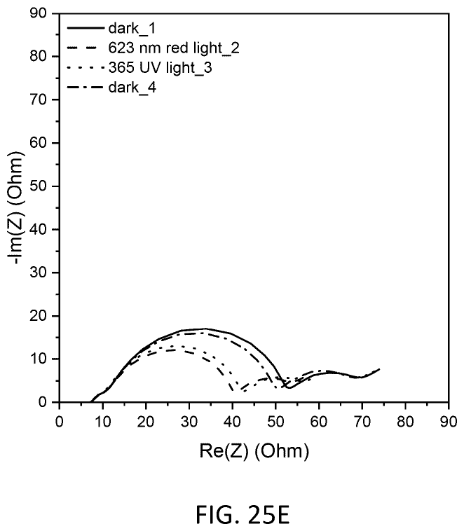

FIGS. 25A-25E show Nyquist plots of a graphite anode at different lithiation states and under different illumination conditions. Nyquist plot of EIS at 0% lithiated state (FIG. 25A); 25% lithiated state (FIG. 25B); 50% lithiated state (FIG. 25C); 75% lithiated state (FIG. 25D); and 100% lithiated state (FIG. 25E).

Electrochemical Impedance Spectroscopy (EIS) is an analytical technique used to investigate the electrochemical properties of materials and interfaces. By applying a small AC voltage across an electrochemical cell and measuring the resulting current over a range of frequencies, EIS provides detailed insights into the processes occurring at the interface. One of the parameters obtained from EIS is the charge transfer resistance (R_{ct}), which represents the resistance to electron transfer at the interface during an electrochemical reaction. R_{ct} is extracted from the Nyquist plot, where it appears as the radius of the semicircle at high to intermediate frequencies. A lower R_{ct} indicates more efficient charge transfer and faster reaction kinetics.

The ohmic resistance in a Nyquist plot is represented by the intercept of the impedance curve with the real axis (the x-axis) at high frequencies. The smaller semi cycle at higher frequency is associated with the charge transfer across the SEI and follows a larger semi cycle represent the interface between the graphite electrode and the electrolyte. At low frequencies, the plot captures slower processes such as diffusion of lithium ions within the electrode material (Warburg impedance).

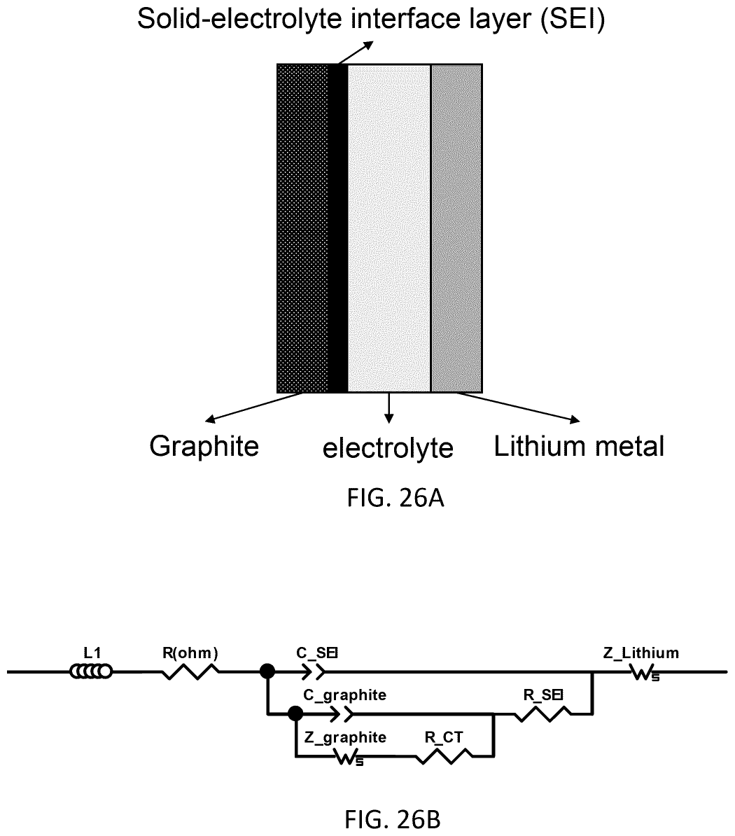

FIGS. 26A and 26B provide a schematic of a lithium-ion cell with a graphite anode with a solid-electrolyte interphase and the corresponding equivalent circuit model, respectively. The equivalent circuit model was used to interpret the Nyquist plots in FIGS. 25A-25E. The equivalent circuit in FIG. 26B uses Gaberscek's SCR model, as described in Jean-Marcel Atebamba et al., 2010, J. Electrochem. Soc., 157, A1218, which is incorporated by reference herein.

TABLE 5
Equivalent circuit components in the equivalent
circuit in FIG. 26B.

| Symbol | Equivalent circuit component |
|---|---|
| L1 | Inductor |
| R(ohm) | Ohmic resistance |
| C_SEI | Double layer capacitance at electrolyte -SEI interface |
| C_graphite | Double layer capacitance at graphite-SEI interface |
| Z_graphite | Ion diffusion resistance in graphite |
| R_CT | Charge transfer resistance at graphite-SEI interface |
| R_SEI | Charge transfer resistance at electrolyte-SEI interface |
| Z_Lithium | Ion diffusion resistance at Lithium metal-electrolyte |
| | interface |

The SEI layer on graphite anodes forms during the first lithiation cycle and grows until it passivates the electrode surface, preventing or reducing further electrolyte decomposition. The SEI layer is composed of a complex mixture of organic and inorganic compounds, including lithium carbonate (Li₂CO₃), lithium oxide (Li₂O), lithium fluoride (LiF), and various organic decomposition products. As a thin layer, the time constants associated with charge transfer across the SEI are relatively short, leading to a higher frequency response.

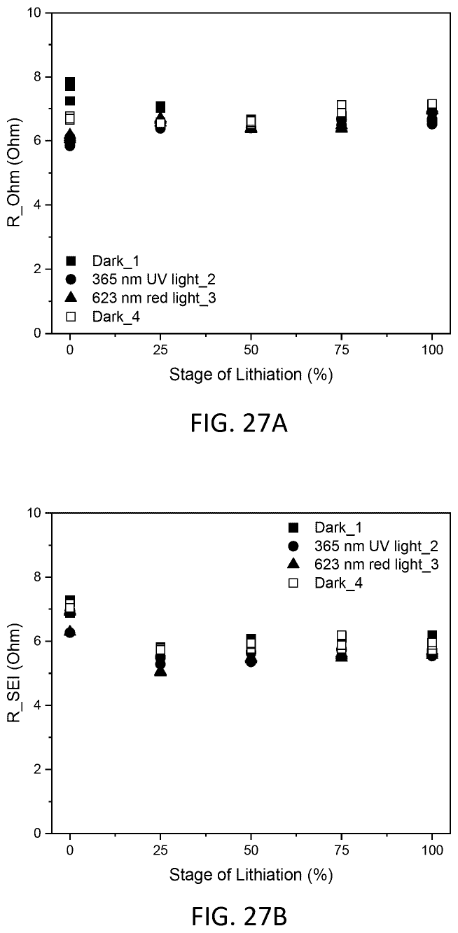

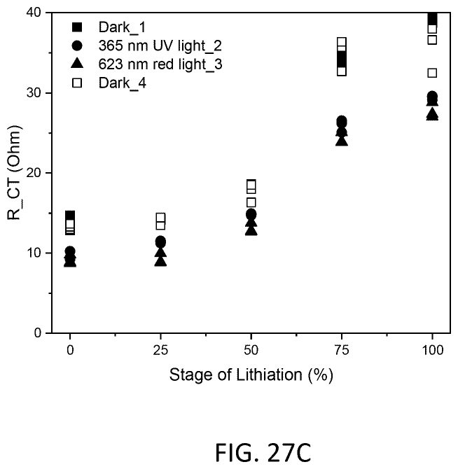

FIGS. 27A-27C show graphs of EIS equivalent circuit fitting result of Ohmic resistance (FIG. 27A); charge resistance at the electrolyte-SEI interface (FIG. 27B); and charge transfer resistance at the graphite-electrolyte interface (FIG. 27C). Resistance measurements were calculated using the Nyquist plots in FIGS. 25A-25E and the equivalent circuit in FIG. 26B.

The ohmic resistance, also known as the electrolyte resistance or series resistance, typically remains unchanged during electrochemical testing. As shown in FIG. 27A, the fitting results indicated that the average value of ohmic resistance was around 6.8 Ohms without illumination. Light illumination with red or UV light reduced the ohmic resistance by about 0.5 Ohms across lithiation states.

After the formation cycles, the graphite was passivated, and the characteristics of the SEI layer are not expected to change significantly. As shown in FIG. 27B, the charge transfer resistance of the SEI-electrolyte interface (R_{SEI}) remained relatively constant with lithium intercalation and under different light illumination conditions, with a value close to about 6 Ohms.

At the earlier stages of lithiation (i.e., less than 50% lithiation), the graphite electrode exhibited a relatively rapid lithium intercalation rate with a smaller charge transfer resistance (R_{CT}) at the graphite-electrolyte interface. As shown in FIG. 27C, the R_{CT} of the graphite-electrolyte interface at a lithiation state of 0% and 25% was around 12 ohms without illumination (i.e., in the dark). A slower reaction occurred when forming LiC6, resulting in a higher R_{CT} at the graphite-electrolyte interface towards the end of lithiation (i.e., greater than 50% lithiation). The larger R_{CT} change occurred between 50%-75% lithiation, increasing from about 18 Ohms to about 33 Ohms, and then slightly increasing to about 38 ohms when fully lithiated. As shown in FIG. 27C, the same general trends for lithiation were present when graphite electrode was illuminated with either red or UV light, but at R_{CT} values about 1 Ohm to about 7 Ohms less than without illumination.

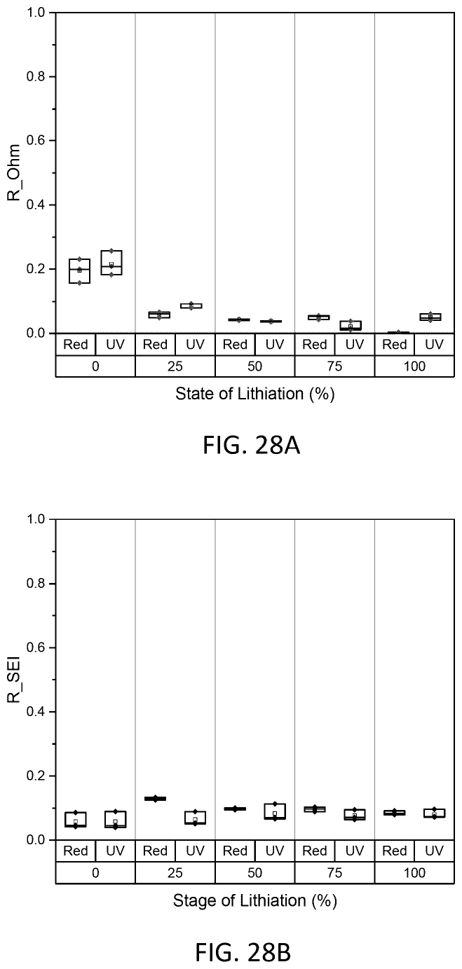

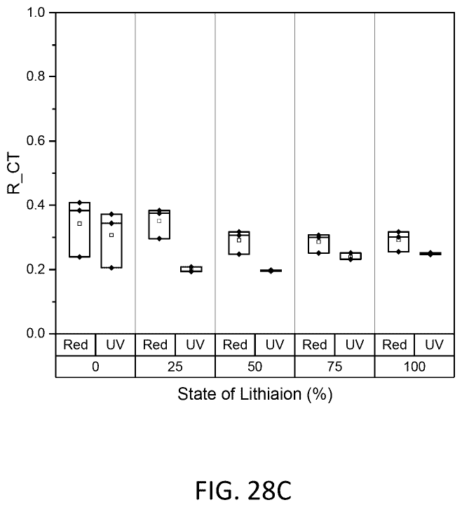

FIGS. 28A-28C show graphs of resistance decrease ratios comparing illumination with red light or UV light as compared to dark conditions using the values in FIGS. 27A-27C. As shown, in FIG. 28B, the charge transfer resistance of the SEI (R_{SEI}) decreased by about 1% to about 10% with red or UV light illumination. As shown in FIG. 28C, light illumination significantly decreased the R_{CT} at the graphite-electrolyte interface. With red light illumination, R_{CT} decreased by more than 30%. Under UV light illumination, the resistance decrease varied from about 19% to about 25% depending on lithiation state. This result suggests a faster reaction rate at the graphite interface with light illumination.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any clement not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method for cycling an electrochemical cell from a first discharged state to a first charged state and from the first charged state to the first discharged state,
wherein the electrochemical cell comprises a cathode active material having a cathode band gap, an anode active material having an anode band gap, and an electrolyte;
the method comprising:
determining the band gap of the cathode active material, the band gap of the anode active material, or the band gap of each of the cathode active material and the anode active material;
illuminating:
the cathode active material with light having a first range of wavelengths that overlaps with the band gap of the cathode active material; or
the anode active material with light having a second range of wavelengths that overlaps with the band gap of the anode active material; or
both the cathode active material with light having a first range of wavelengths that overlaps with the band gap of the cathode active material and the anode active material with light having a second range of wavelengths that overlaps with the band gap of the anode active material; and
applying a voltage bias to charge the electrochemical cell from the first discharged state to the first charged state;
wherein:
the electrochemical cell is a lithium ion battery, a sodium ion battery, a potassium ion battery, a magnesium ion battery, a lithium-air battery, a lithium-oxygen battery, or a lithium-sulfur battery; and
a time period required to charge the electrochemical cell from the first discharged state to the first charged state while illuminated is less than a time period required for charging the electrochemical cell while not illuminated or illuminated with light that does not have a wavelength that overlaps with the band gap of the cathode active material, the anode active material, or both the cathode active material and the anode active material.

2. The method of claim 1, wherein the first range of wavelengths of light substantially matches the band gap of the cathode active material, and the second range of wavelengths of light substantially matches the band gap of the anode active material.

3. The method of claim 1, wherein the first range of wavelengths of light is within the band gap of the cathode active material, and the second range of wavelengths of light is within the band gap of the anode active material.

4. The method of claim 1, wherein the first range of wavelengths of light is red light.

5. The method of claim 4, wherein a source of the red light is a light emitting diode, a xenon lamp, or a laser.

6. The method of claim 1, wherein the second range of wavelengths of light is ultraviolet light.

7. The method of claim 6, wherein the ultraviolet light is a light emitting diode, a xenon lamp, or a laser.

8. The method of claim 1, wherein the electrochemical cell is a lithium ion battery.

9. The method of claim 1, wherein the electrochemical cell is a sodium ion battery.

10. The method of claim 1, wherein the electrochemical cell is a potassium ion battery.

11. The method of claim 1, wherein the electrochemical cell is a magnesium ion battery.

12. The method of claim 1, wherein the electrochemical cell is a sulfur battery.

13. The method of claim 1, wherein the cathode active material comprises a spinel, an olivine, a carbon-coated olivine, LiFePO₄, LiCoO₂, LiNiO₂, LiNi₁₋ₓCo_{y}M⁴_{z}O₂, LiMn_{0.5}Ni_{0.5}O₂, LiMn_{1/3}Co_{1/3}Ni_{1/3}O₂, LiMn₂O₄, LiFeO₂, LiM⁴_{0.5}Mn_{1.5}O₄, Li_{1+x″}Ni_{α}Mn_{β}Co_{γ}M⁵_{δ′}O_{2-z″}F_{z″}, A_{n′}B¹₂(M²O₄)₃, or VO₂;
wherein:
M⁴ is Al, Mg, Ti, B, Ga, Si, Mn, or Co;
M⁵ is Mg, Zn, Al, Ga, B, Zr, or Ti;
A is Li, Ag, Cu, Na, Mn, Fe, Co, Ni, Cu, or Zn;
B¹ is Ti, V, Cr, Fe, or Zr;
0≤x≤0.3; 0≤y≤0.5; 0≤z≤0.5; 0≤x″≤0.4; 0≤α≤1; 0≤β≤1; 0≤γ≤1; 0≤δ′≤0.4; 0≤z″≤0.4; and 0≤n′≤3;
with the proviso that at least one of α, β and γ is greater than 0.

14. The method of claim 1, wherein the cathode active material comprises LiFePO₄, LiCoO₂, LiNiO₂, LiNiₓMn_{y}O₂ where 0<x≤0.95 and x+y equals 1, LiMn_{0.5}O₂, LiMn_{1/3}Co_{1/3}Ni_{1/3}O₂, LiMn_{0.3}Co_{0.2}Ni_{0.5}O₂, LiMn_{0.2}Co_{0.2}Ni_{0.6}O₂, LiMn_{0.1}Co₀₁Ni_{0.8}O₂, LiMn₂O₄, LiCr_{0.5}Mn_{1.5}O₄, LiCrMnO₄, LiFe_{0.5}Mn_{1.5}O₄, LiCoMnO₄, LiNi_{0.5}Mn_{1.5}O₄, LiNiPO₄, LiCoPO₄, LiMnPO₄, LiCoPO₄F, Li₂MnO₃, Li₅FeO₄, or Li_{x′}(Met)O₂; wherein: Met is a transition metal and 1<x′≤2.

15. The method of claim 1, wherein the cathode active material comprises a disordered rock salt Li₁₊ₓMO_{2+δ} where M is Mg, Zn, Al, Ti, a transition metal, or any combination of two or more thereof; a disordered layered Li₁₊ₓMO_{2+δ} where M is Mg, Zn, Al, Ti, a transition metal, or any combination of two or more thereof; a disordered spinel cathode material; a layered-spinel cathode material; a layered-layered-spinel cathode material; a DRX composite; an intergrowth of any two or more thereof; or any combination of two or more thereof.

16. The method of claim 1, wherein the anode active material comprises lithium, sodium, magnesium, sulfur, a conductive carbon material, silicon, silicon oxide, TiO₂, Li₄Ti₅O₁₂, or a mixture of any two or more thereof.

17. The process of claim 1, wherein the electrochemical cell further comprises a separator between the cathode and the anode.

18. The process of claim 1, further comprising:
applying a constant current to discharge the electrochemical cell from the first discharged state to the first charged state;
wherein a time period required to discharge the electrochemical cell from the first charged state to the first discharged state while illuminated is less than a time period required for discharging the electrochemical cell while not illuminated or illuminated with light that does not have a wavelength that overlaps with the band gap of the anode active material.

19. A method for discharging a charged electrochemical cell from a first charged state to a first discharged state,
wherein the charged electrochemical cell comprises a cathode active material having a cathode band gap, an anode active material having an anode band gap, and an electrolyte;
the method comprising:
determining a band gap of the anode active material;
illuminating the anode active material with light having a first range of wavelengths that overlaps with the band gap of the anode active material; and
applying a constant current to discharge the charged electrochemical cell from the first charged state to the first discharged state;
wherein:
the electrochemical cell is a lithium ion battery, a sodium ion battery, a potassium ion battery, a magnesium ion battery, a lithium-air battery, a lithium-oxygen battery, or a lithium-sulfur battery; and
a time period required to discharge the charged electrochemical cell from the first charged state to the first discharged state while illuminated is less than a time period required for discharging the charged electrochemical cell while not illuminated or illuminated with light that does not have a wavelength that overlaps with the band gap of the anode active material.

20. The method of claim 19, wherein the first range of wavelengths of light substantially matches the band gap of the anode active material.

21. The method of claim 19. wherein the first range of wavelengths of light is within the band gap of the anode active material.

22. The method of claim 19, wherein the anode active material comprises at least one of Li₄Ti₅O₁₂ or graphite and the range of first wavelengths of light is ultraviolet light.
